(19) United States
(12) Patent Application Publication
(10) Pub. No.: US 2026/0180713 A1
(43) Pub. Date: Jun. 25, 2026

(54) POST-FEC BER ESTIMATION AND ADAPTING FORWARD ERROR CORRECTION (FEC) OR COMMUNICATION LINK PARAMETERS USING DEEP NEURAL NETWORKS FOR IMPROVED POST-FEC PERFORMANCE

(71) Applicant: NVIDIA Corporation, Santa Clara, CA (US)

(72) Inventors: Pervez Mirza Aziz, Dallas, TX (US); Vishnu Balan, Saratoga, CA (US); Mohammad Shafiul Mobin, Murphy, TX (US)

(21) Appl. No.: 19/176,831

(22) Filed: Apr. 11, 2025

Related U.S. Application Data
(60) Provisional application No. 63/737,344, filed on Dec. 20, 2024.

(51) Int. Cl. H04L 1/00; H04L 1/20

(52) U.S. Cl. CPC H04L 1/0045; H04L 1/0071; H04L 1/203

(57) ABSTRACT

Technologies for optimizing post-FEC bit error rate (BER) performance of a Forward Error Correction (FEC) system are described. The processing device receives measurement data including transmitter settings and impairment properties associated with a transmitter circuit, channel properties and impairment properties associated with a channel between the transmitter circuit and a receiver circuit, link properties and impairment properties associated with a link between the transmitter circuit and the receiver circuit, and/or receiver settings and impairment properties associated with the receiver circuit. The processing device determines, using the measurement data and a deep neural network (DNN), a post-FEC BER estimation of a FEC circuit. The processing device adjusts, based on the post-FEC BER estimation, at least one of a FEC parameter of the FEC circuit or a link parameter of the transmitter or receiver circuit to improve the post-FEC performance of the FEC circuit.

### RELATED APPLICATIONS

This application claims the benefit of U.S. Provisional Application No. 63/737,344, filed Dec. 20, 2024, the entire contents of which are incorporated herein by reference. This application is related to U.S. application Ser. No. 18/112,406, filed Feb. 21, 2023, and U.S. application Ser. No. 18/913,619, filed Oct. 11, 2024, the entire contents of which are incorporated herein by reference.

### TECHNICAL FIELD

At least one embodiment pertains to processing resources used to perform high-speed communications, including estimating or predicting post-Forward Error Correction (FEC) bit error rate (BER) and optimizing a system for post-FEC BER performance. For example, at least one embodiment pertains to technology for estimating post-FEC BER and adapting FEC or communication link parameters using deep neural networks (DNNs) for improved post-FEC BER performance.

### BACKGROUND

Communication systems employ an architecture with a combination of a transmitter/receiver circuit (e.g., Serializer/Deserializer (SerDes) circuit) in conjunction with a Forward Error Correction (FEC) system for the transmission of signals from a transmitter to a receiver via a communication channel or medium (e.g., cables, printed circuit boards, optical fibers, etc.). The SerDes system performs equalization of the signal over the communication channel to achieve a desired bit error ratio (BER). An FEC encoder encodes data on the transmit side before using a SerDes transmitter (TX) to transmit the data through a communication channel. The SerDes receiver (RX) receives an analog input signal at the output of the communication channel, and recovers the data as a decoded binary bit stream while achieving a certain BER performance (called “pre-FEC BER performance”) before sending that data through an FEC decoder to further improve the BER to achieve a post-FEC BER after decoding.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of a communication system having a DNN-based estimation system to optimize post-FEC BER performance of an FEC system according to at least one embodiment.

FIG. 2 is a block diagram of a communication system having a DNN-based estimation system to optimize post-FEC BER performance of an FEC system for a linear or direct drive multi-part optical link with interleavers according to at least one embodiment.

FIG. 3 illustrates an example of FEC symbol interleaving with an interleave factor of four for an encoded FEC codeword according to at least one embodiment.

FIG. 4 are block diagrams of three high-level types of post-FEC BER estimation techniques according to various implementations.

FIG. 5 is a block diagram of a DNN training and DNN inference architecture according to at least one embodiment.

FIG. 6 is a block diagram of a post-FEC BER estimation architecture using DNN based training according to at least one embodiment.

FIG. 7 is a block diagram of an alternative architecture for post-FEC training and inference according to at least one embodiment.

FIG. 8 is a block diagram of an overall link overall link/SerDes/FEC architecture incorporating DNN based training according to at least one embodiment.

FIG. 9 is a block diagram of an overall link overall link/SerDes/FEC architecture incorporating DNN based inference according to at least one embodiment.

FIG. 10 is a block diagram of an alternative framework for training/inference according to at least one embodiment.

FIG. 11 is a block diagram illustrating periodic inference while keeping some parameters from inference fixed while varying other inference parameters, where k represents the time period at which post-FEC BER is re-inferred according to at least one embodiment.

FIG. 12 illustrates a method 1200 in accordance with one embodiment.

FIG. 13 illustrates an example computer system, including a network controller with a DNN-based estimation system for optimizing post-FEC BER performance of an FEC system, in accordance with at least some embodiments.

FIG. 14A illustrates an example communication system with a DNN-based estimation system for optimizing post-FEC BER performance of an FEC system, in accordance with at least some embodiments.

FIG. 14B illustrates a block diagram of an example communication system employing a receiver with a DNN-based estimation system for optimizing post-FEC BER performance of an FEC system, according to at least one embodiment.

FIG. 15 is a block diagram of a computing system having two processing devices coupled to each other and multiple networks according to at least one embodiment.

FIG. 16 is a block diagram of a computing system having a central processing unit (CPU) and a graphics processing unit (GPU) in a single integrated circuit according to at least one embodiment.

FIG. 17 is a block diagram of a computing system having tensor core graphics processing units (GPUs) according to at least one embodiment.

FIG. 18A illustrates inference and/or training logic, according to at least one embodiment of the present disclosure.

FIG. 18B illustrates inference and/or training logic, according to at least one embodiment.

FIG. 19 illustrates training and deployment of a neural network, according to at least one embodiment.

FIG. 20 is an example data flow diagram for an advanced computing pipeline, according to at least one embodiment.

FIG. 21 is a system diagram for an example system for training, adapting, instantiating, and deploying machine learning models in an advanced computing pipeline, according to at least one embodiment.

FIG. 22 illustrates a computer system, according to at least one embodiment.

FIG. 23 illustrates a computer system, according to at least one embodiment.

### DETAILED DESCRIPTION

As described above, communication systems employ a combination of a transmitter/receiver circuit (e.g., Serializer/Deserializer (SerDes) circuit) in conjunction with an FEC system, including an FEC encoder that encodes data on the transmit side before using the transmitter (TX) to transmit the data through a communication channel. The receiver (RX) (SerDes receiver) receives an analog input signal at the output of the communication channel, and recovers the data as a decoded binary bit stream while achieving a certain BER performance before sending that data through an FEC decoder to further improve the BER. The FEC system may perform data interleaving of various types. There are FEC-related parameters that can be adjusted, but these parameters are usually static in a system thus locking the system into a specific apriori chosen performance/power/latency tradeoff, where the latency is latency through the FEC system.

The TX/RX hardware (e.g., SerDes hardware), on the other hand, often has many link parameters that can be adapted either directly on the SerDes hardware or through the use of an external controller. However, the external controller uses these link parameters to optimize the SerDes performance based on some pre-FEC performance criteria, such as pre-FEC BER or least mean squared error criteria. That is, the controller measures the pre-FEC BER performance to optimize the SerDes parameters. A well-equalized signal giving good pre-FEC BER may distribute errors that are not favorable to the FEC and post-FEC performance. However, it is not practical to measure post-FEC BER directly, creating a need for metrics which will correlate well with post-FEC performance. There is no practical way to measure the post-FEC BER performance of the FEC system at low post-FEC BER values where a system would typically operate. Thus, conventional systems do not use communication link or FEC-related parameters to optimize the post-FEC BER performance of the FEC systems.

Aspects and embodiments of the present disclosure address these and other challenges by providing post-FEC BER estimation or prediction employing deep neural networks (DNN). Aspects and embodiments of the present disclosure can be used for estimation/prediction with little or no transient simulation or silicon data collecting during final inference. Aspects and embodiments of the present disclosure perform adaptations of FEC or communication link parameters (e.g., SerDes parameters) based on the estimated post-FEC BER.

Previous solutions relied on extensive data collection based on transient (time domain) simulation or silicon of various data statistics, such as codeword, burst or signal-to-noise ratio (SNR) histograms. These data statistics are processed using a semi-analytic post-FEC BER prediction model to estimate the post-FEC BER performance. Aspects and embodiments of the present disclosure can train a DNN for post-FEC BER estimation purposes such that, after training is complete, post-FEC BER performance can be estimated with significantly reduced or no data collection of data statistics based on transient simulation or silicon data collection.

As described above, the FEC related parameters are usually static in a system thus locking the system into a specific apriori chosen performance/power/latency tradeoff where the latency referred to is latency through the FEC system. Aspects and embodiments of the present disclosure use DNN based post-FEC BER performance estimation for the adaptation or change of FEC related parameters to optimize post-FEC BER performance. Aspects and embodiments of the present disclosure can optimize selected SerDes or link component parameters for post-FEC BER performance by considering only such parameters which are likely to have a large impact on post-FEC BER performance rather than a secondary impact.

Aspects and embodiments of the present disclosure can be applied to any communication system employing forward error correction. The communication system can include serial links (e.g., printed circuit board (PCB) links, copper cables, optical links, read channels (e.g., —systems including but not limited to serial links (PCB/copper cable/optical links etc.), read channel applications (e.g., hard disk, flash SSDs application), or the like. The communication system can be implemented in a personal computer (PC), a set-top box (STB), a server, a network router, a switch, a bridge, a data processing unit (DPU), a network card, a data center, communication links in automobile systems, or any device or system capable of sending signals over a communication channel to another device.

It should be noted that in the subsequent discussions, the reference to post-FEC BER may refer to its actual value (e.g., 1e⁻²⁴) or equivalent log₁₀ value (e.g., −24 for 1e⁻²⁴ actual value). Most of the mathematical operational usage of the post-FEC BER can happen in the log₁₀ domain but the transformation between actual value and log₁₀ domain or vice-versa is a trivial operation. Also, although there are references to post-FEC BER as the post-FEC performance criteria, all concepts regarding post-FEC BER can be equally applicable to metrics such as post-FEC codeword failure rate (CFR), also known as block error rate (BLER), which are related to post-FEC BER by simple well known relationships.

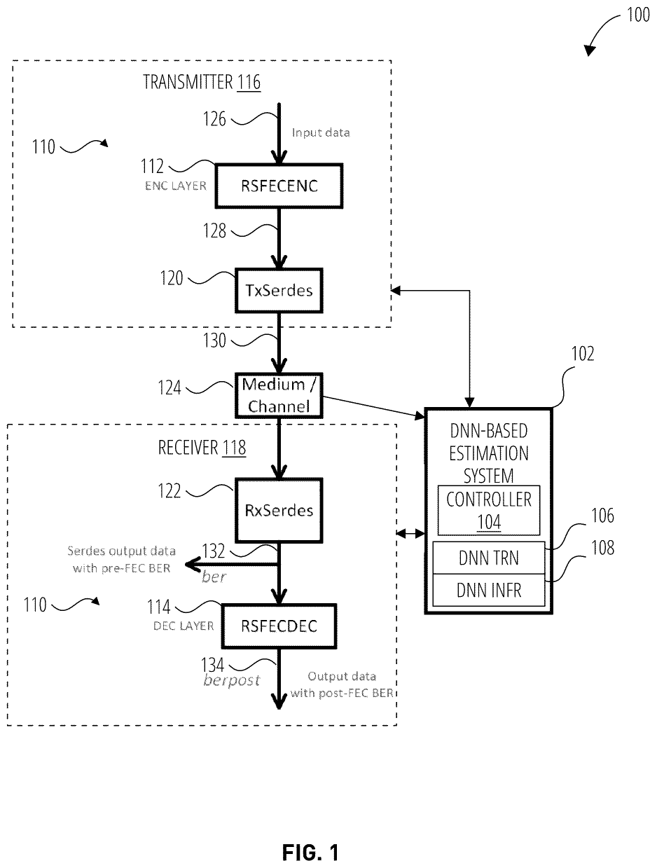

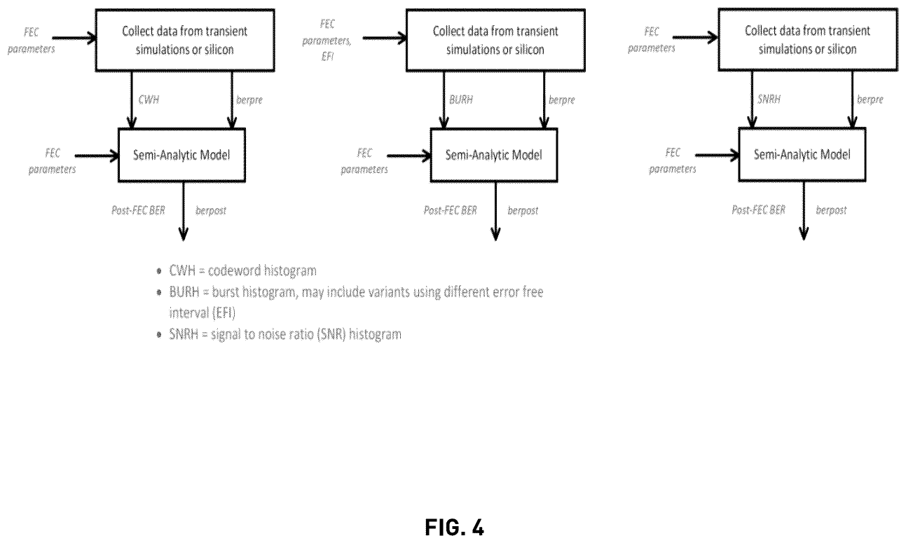

FIG. 1 is a block diagram of a communication system 100 having a DNN-based estimation system 102 to optimize post-FEC BER performance of an FEC system 110 according to at least one embodiment. The DNN-based estimation system 102 is described in more detail below with respect to FIG. 4 to FIG. 10, whereas FIG. 1 to FIG. 3 describe communication systems in which the DNN-based estimation system 102 can be used.

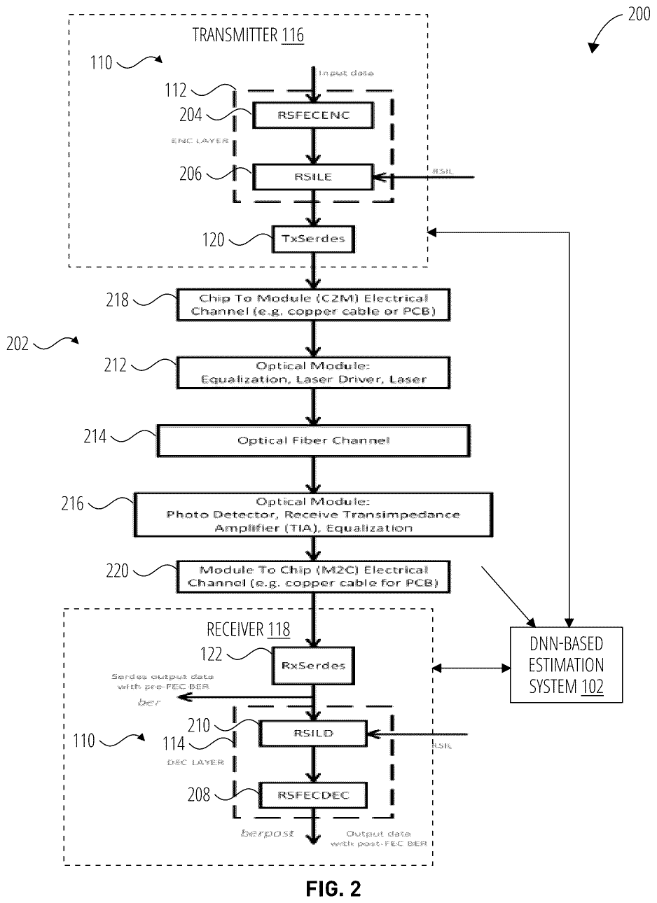

The communication system 100 can include an FEC system 110 and a SerDes system connected to a communication channel 124. In particular, the communication system 100 includes a transmitter 116 (also referred to as a transmitter device or transmitting device), a receiver 118 (also referred to as a receiver device or receiving device), and the DNN-based estimation system 102 operatively coupled to the FEC system 110 and receiver 118. In particular, the DNN-based estimation system 102 can receive data from the encoding layer 112, the transmitter circuit 120, the communication channel 124, the receiver circuit 122, and the decoding layer 114, as described in more detail below. In this embodiment, the FEC system 110 includes one or more FEC engines, such as Reed-Solomon (RS) FEC engines, with an RS code and RS interleaving (RSILE, RSILD), as illustrated in FIG. 2. In other embodiments, other error correcting codes can be used, such as a Bose-Chaudhuri-Hocquenghem code (BCH code) and BCH interleaving (BCHILE, BCHILD), Hamming codes, extended Hamming codes, Golay codes, parity codes including low density parity check (LDPC) codes, multidimensional parity codes, triple modular redundancy codes, Nordstrom-Robinson codes, cyclic redundancy checks (CRC) codes, or the like.

In at least one embodiment, the transmitter 116 is part of a first transceiver that also includes a receiver (not illustrated in FIG. 1) and the receiver 118 is part of a second transceiver that also includes a transmitter (not illustrated in FIG. 1). The transmitter 116 includes a transmitter circuit 120, such as a SerDes TX circuit. The transmitter circuit 120 sends signals over a communication channel 124 (also referred to as “channel,” “communication medium,” or “transmission medium”) The receiver 118 includes a receiver circuit 122, such as a SerDes RX circuit. The receiver circuit 122 receives signals over the communication channel 124.

In at least one embodiment, the FEC system 110 includes an encoding layer 112 at the transmitter 116 and a decoding layer 114 at the receiver 118. The encoding layer 112 can encode input data 126 (e.g., user or input bits) into forward error correction (FEC) codewords 128 which can be mapped to FEC symbols and bits before being sent to the transmitter circuit 120. In at least one embodiment, the FEC system 110 uses the Reed-Solomon (RS) FEC algorithm. The encoding layer 112 can thus be an RS FEC encoder (RSFECENC). Other encoding operations may be performed in the encoding layer 112 (and decoding operations in the decoding layer 114). In other embodiments, other encoding operations can be performed in the transmitter circuit 120 and receiver circuit 122, such as precoding, Gray coding, run length encoding, or the like. During the encoding process, the encoding layer 112 (e.g., RSFECENC) usually processes groups of bits called FEC symbols, which are typically groups of say 8 or 10 bits at a time, and then FEC codewords 128, which depending on the FEC, can include many FEC symbols. Of course, the equivalent binary bits or equivalent modulated symbols (e.g., PAM4 symbols) are the ones actually sent by the transmitter circuit 120 (e.g., SerDes TX circuit) through a transmission medium or communication channel 124 which produces an analog waveform. In particular, after the encoding process, the transmitter circuit 120 (e.g., SerDes TX circuit) sends the equivalent binary bits in a bit stream or equivalent modulated symbols 130 as an analog waveform through communication channel 124 as illustrated in FIG. 1. The receiver circuit 122 (e.g., SerDes RX circuit) processes the analog signal, performing operations, such as equalization/detection, clock/data recovery, and produces a bit stream 132, which in the absence of impairments or noise in the communication channel 124 would match the transmitted bit stream 130 at the SerDes TX input.

It should be noted that the bits of the bit stream 132, at the output of the receiver circuit 122 (e.g., SerDes RX circuit), are produced with a finite pre-FEC BER. This finite pre-FEC BER can be high. These pre-FEC bits at the output of the receiver circuit 122 (e.g., SerDes RX circuit) are typically grouped again as FEC symbols for the decoding layer 114. During the decoding process, the decoding layer 114 decodes the RX SerDes output to produce output data 134. The underlying bits of the output data 134 have significantly improved (i.e., lower) post-FEC BER than the pre-FEC BER observed at the SerDes RX output. In at least one embodiment, the decoding layer 114 is a RS decoder (e.g., RSFECDEC). Other encoding and decoding FEC algorithms can be used for the encoding layer 112 and decoding layer 114. It should be noted that the receiver circuit 122 (e.g., SerDes RX circuit) may use an external controller 104 to aid the adaptation of one or more of its internal parameters to optimize the pre-FEC BER performance at the output of the receiver circuit 122 (e.g., SerDes RX circuit). It should be noted that the terms encoding/decoding layers are generic terms, but the functionality of these layers can be found in systems that use other terminologies, such as physical coding sub-layer (PCS) in the IEEE standards, or the like. Other standards bodies may have other names for where such functionality resides.

In addition, interleaving may be applied in conjunction with the FEC system. In at least one embodiment, the encoding layer 112 can include an FEC encoder and a first interleaver, and the decoding layer 114 can include an FEC decoder and a second interleaver. The second interleaver may also be called a “de-interleaver.” The interleaving may be of various types, either operating on bits, pairs of bits, or FEC symbols. Depending on the interleaver type, the first interleaver reorders groups of bits, pairs of bits, or FEC symbols on the encoding side, and the second interleaver performs the reverse operation on the decoding side. It should be noted that the use of an interleaver causes additional latency through the communication system. The higher the interleave factor, the longer the additional latency.

In other embodiments, the system can include other components, such as illustrated and described below with respect to FIG. 2.

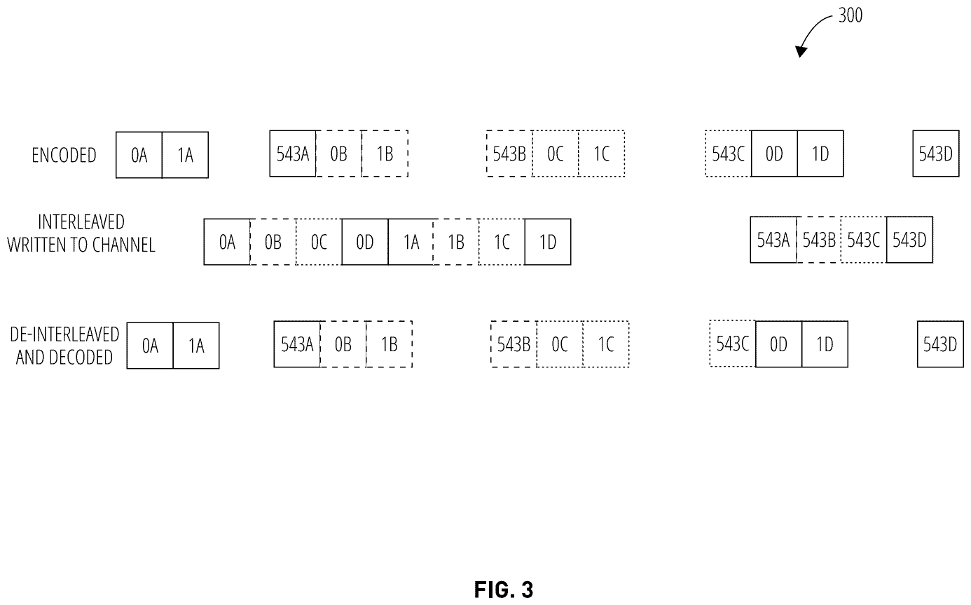

FIG. 2 is a block diagram of a communication system 200 having a DNN-based estimation system 102 to optimize post-FEC BER performance of an FEC system 110 for a linear or direct drive multi-part optical link 202 with interleavers, according to at least one embodiment. The communication system 200 is similar to communication system 100, except the communication system 200 includes a linear or direct drive multi-part optical link 202 with interleavers. As described above, interleaving may be applied in conjunction with the FEC system. In at least one embodiment, the encoding layer 112 can include the FEC encoder 204 and a first interleaver 206. In at least one embodiment, the decoding layer 114 can include the FEC decoder 208 and a second interleaver 210. The second interleaver 210 may also be called a “de-interleaver.” This interleaving for the FEC encoder 204 (RSFEC) is denoted as RSILE for the first interleaver 206 in the encoding layer 112 and RSILD for the second interleaver 210 in the decoding layer 114. The interleaving may be of various types, either operating on bits, pairs of bits, or FEC symbols. Depending on the interleaver type, the first interleaver 206 reorders groups of bits, pairs of bits, or FEC symbols on the encoding side, and the second interleaver 210 performs the reverse operation on the decoding side. A common form of interleaving is FEC symbol interleaving by an interleave factor (denoted as RSIL) when used in conjunction with the FEC encoder 204 (RSFECENC). An example of FEC symbol interleaving with RSIL=4 is shown in FIG. 3 for an encoded FEC codeword size of Nfec=544. It should be noted that the use of an interleaver causes additional latency through the communication system. The higher the interleave factor, the longer the additional latency.

In addition to the interleavers, the optical link 202 includes other components, such as a transmit optical module 212, optical fiber 214, and receive optical module 216. The TX optical module 212 may include additional equalization, a laser driver, and a laser. The RX optical module 216 may be comprised of a photodiode, receive transimpedance amplifier (RXTIA), and additional equalization. The optical link 202 can include a chip-to-module (C2M) electrical channel (e.g., copper cable or PCB) on the TX side and a module-to-chip (M2C) electrical channel (e.g., copper cable or PCB) on the RX side, labeled as C2M electrical channel 218 and M2C electrical channel 220. Other variants of the optical links involving the use of classical re-timer blocks or re-timer blocks on one or both sides of the link are also possible.

The interleaving may be of various types, either operating on bits, pairs of bits, or FEC symbols. Depending on the interleaver type, it reorders groups of bits, pairs of bits, or FEC symbols on the encode side and performs the reverse operation on the decoding side. A common form of interleaving is FEC symbol interleaving by some factor, which we denote as RSIL when used in conjunction with an RS FEC. An example of FEC symbol interleaving with RSIL=4 is shown in FIG. 3 for an encoded FEC codeword size of 544 (Nfec=544). The use of an interleaver causes additional latency through the system; the higher the interleave factor, the longer the additional latency.

FIG. 3 illustrates an example of FEC symbol interleaving with an interleave factor of four for an encoded FEC codeword 300 according to at least one embodiment. The encoded FEC codeword 300 has a codeword size of 544. Each square represents one FEC symbol and each line pattern represents an adjacent FEC codeword after initial encoding.

### DNN-Based Post-FEC Estimation

Referring back to FIG. 1, as described above, until now, post-FEC estimation has relied on extensive data collection based on transient (time domain) simulation or silicon of various data statistics such as codeword, burst, or signal-to-noise (SNR) histograms, which are then processed using a semi-analytic post-FEC BER prediction model to estimate the post-FEC BER. Thus, a deep neural network (DNN) can be trained for post-FEC BER estimation, such that after training is complete, post-FEC BERs can be estimated with significantly reduced or no data collection based on transient simulation or silicon data.

Also, as described herein, there are FEC-related parameters of the FEC system 110 that can be adjusted by the DNN-based estimation system 102. Conventionally, FEC-related parameters are static in a conventional FEC system, locking the conventional FEC system into a specific a priori chosen performance/power/latency tradeoff. The DNN-based estimation system 102, as described in the various embodiments here, determines a post-FEC correlated performance metric indicative of an estimated post-FEC BER of the FEC system 110 in order to optimize post-FEC BER performances of the FEC system 110. The post-FEC correlated performance metrics are metrics that correlate well with post-FEC BER performance. The DNN-based estimation system 102 can dynamically adapt the FEC-related parameters of the FEC system 110 to optimize the post-FEC BER performance. The FEC-related parameters can be encoding/decoding layer parameters. In at least one embodiment, the FEC-related parameters include an interleave factor (RSIL), as illustrated in FIG. 2.

In at least one embodiment, the transmitter circuit 120 and receiver circuit 122 have link parameters (e.g., SerDes parameters). In at least one embodiment, the link parameter is a phase noise parameter of a phase-locked loop (PLL) of the receiver circuit 122. In at least one embodiment, the DNN-based estimation system 102 can dynamically adapt the link parameters of the transmitter circuit 120 and receiver circuit 122 to optimize the post-FEC BER performance. It should be noted that conventionally, the link parameters could be adjusted, but they were adjusted based on some pre-FEC performance criteria. That is, a conventional controller would only measure the pre-FEC BER performance to optimize the SerDes parameters. As described above, there is no practical way to measure the post-FEC BER performance of the FEC system 110 directly for low post-FEC BERs where a system would typically operate. An exception where post-FEC can actually be measured (be it in simulation or silicon) is to exacerbate the system impairments such as noise or jitter to manifest actual post-FEC errors.

The embodiments described herein allow the SerDes parameters to be optimized based on post-FEC performance criteria by training a DNN to aid in post-FEC BER estimation and using the trained DNN to infer post-FEC BER to dynamically optimize performance. The DNN-inferred post-FEC BER can be used to dynamically optimize performance tradeoffs by adapting FEC parameters, such as the FEC interleaving factor. Also, selected SerDes or link parameters could also be optimized or adapted for best post-FEC performance. In particular, the embodiments described herein can modify or adjust link parameters and/or FEC-related parameters to optimize the post-FEC BER performance of the FEC system 110. The link parameters can be adapted either directly on the SerDes hardware (e.g., transmitter circuit 120 and receiver circuit 122) or through use of an external controller 104 (also referred to as an adaptation controller, which could be a microcontroller (MCU) or FPGA that is separate from the DNN-based estimation system 102, which could have one or more GPUs for processing data for training the DNN and making inferences using the trained DNN). In at least one embodiment, the DNN-based estimation system 102 is implemented as one or more processing devices, such as a GPU for computations and operations of the DNN training logic 106 and DNN inference logic 108 and a controller 104 for adapting the FEC parameters and the link parameters. In at least one embodiment, the DNN-based estimation system 102 is implemented in an auxiliary device, such as a Deep Learning Accelerator (DLA), a data processing unit (DPU), or the like.

In at least one embodiment, the DNN-based estimation system 102 includes DNN training logic 106 and DNN inference logic 108. To estimate post-FEC performance (i.e., post-FEC BER estimation), the DNN training logic 106 can train on certain data across an aggregation of links to create a trained DNN model or models which can be used to subsequently infer post-FEC BER performance for specific links. During the training phase, the DNN training logic 106 can use collections of FEC codeword histograms (i.e., measured FEC codeword histograms), burst histograms, SNR histogram data, and optionally pre-FEC BER measurements obtained via transient simulations of links or silicon data. However, the DNN inference logic 108, during DNN inference, can determine a final post-FEC BER estimation with minimal or even no transient simulation or transient silicon data. The DNN inference logic 108 can use the post-FEC BER estimation to optimize or adapt selected SerDes or link parameters, as well as FEC-related parameters.

### Link Parameters

As described herein, the DNN-based estimation system 102 can adapt link parameters, such as SerDes parameters, to optimize post-FEC BER performance through the use of a post-FEC BER estimation obtained by a trained DNN. Examples of link parameters can include the following examples:
Analog front end (AFE) parameters such as continuous time linear equalizer (CTLE) peaking/boost setting, low-frequency gain setting, low-frequency pole/zero (corner frequency) setting, mid-frequency gain setting, mid-frequency pole/zero (corner frequency) setting.
Receiver feed forward equalizer (RXFFE) fixed tap settings such as first post-cursor f(1) or first pre-cursor f(−1) setting which also significantly affect the phase response of the RXFFE.
   Number of RXFFE taps enabled
   Number of decision feed forward equalizer (DFFE) taps enabled
   Number of digital echo cancellation (DEX) taps enabled
   Number of analog echo cancellation (AEX) taps enabled
   Maximum likelihood sequence detector (MLSD) trace back depth (also known as path memory)

Alternatively, the DNN-based estimation system 102 can adapt other link parameters to optimize post-FEC BER performance through the use of a post-FEC BER estimation obtained by a trained DNN. Also, as described herein, the DNN-based estimation system 102 can adapt both link parameters and FEC parameters together.

### FEC Parameters

As described herein, the DNN-based estimation system 102 can adapt FEC parameters to optimize post-FEC BER performance through the use of a post-FEC BER estimation obtained by a trained DNN. Examples of FEC parameters can include the following examples.
FEC RS interleaving factor (already discussed in detail)
   Concatenated scheme: FEC BCH interleaving factor.
   Hard and soft decision decoding of BCH or RS FEC
   BCH coding enabled or not
   FEC coding scheme.
   Link/FEC retry or not.

Alternatively, the DNN-based estimation system 102 can adapt other FEC parameters to optimize post-FEC BER performance through the use of a post-FEC BER estimation obtained by a trained DNN. Also, as described herein, the DNN-based estimation system 102 can adapt both link parameters and FEC parameters together.

### Codeword and Burst Histograms

The following is a description of codeword and burst histograms for post-FEC BER estimation for training a DNN. There are two histogram types used for traditional post-FEC BER estimation techniques. The histograms are formed from raw FEC symbol error statistics from the SerDes output, which in turn are comprised of raw bit error statistics from the SerDes Rx. Note that in order for the SerDes Rx to compute actual raw bit error information, it must be cognizant of the transmitted bits to be able to make a comparison of the received bits with transmitted bits to be able to determine whether a bit error occurred or not. As is well known to those familiar in the art, such a bit error measurement may be made through the use of a training pattern, such as a pseudo-random bit sequence (PRBS) pattern known to both the SerDes-TX and SerDes Rx. Let e(n) be the bit error stream at bit time n at the SerDes output. Thus, when a bit is in error, we will have e(n)=1, and when a bit is not in error, we will have e(n)=0.

An FEC symbol error stream fe(m) at FEC symbol times m can be constructed from the bit error stream e(n). For a given FEC let L be the number of bits in an FEC symbol. FEC symbol errors are obtained from examining contiguous groups of L bits. If in any group of L bits i.e., bits in a FEC symbol, corresponding with the mth group of such bits, any bit is in error then the corresponding FEC symbol is declared to be in error i.e., fe(m)=1. Only if none of the bits in the group of L bits is in error then the FEC symbol is declared to not be in error i.e., fe(m)=0. This can also be equivalently represented in the following Equation 1:

$$fe ( m ) = {\sum }_{i = n - ( L - 1 )}^{n} e ( n ) , \qquad ( Equation 1 )$$

where it should be noted that the sum represents an ‘or’ sum. For example, for L=8, this would result in the following Equation 2:

$$fe ( m ) = e ( n - 7 ) ⊕ e ( n - 6 ) ⊕ e ( n - 5 ) ⊕ e ( n - 4 ) ⊕ e ( n - 3 ) ⊕ e ( n - 2 ) ⊕ e ( n - 1 ) ⊕ e ( n ) , \qquad ( Equation 2 )$$

where ⊕ represents the ‘or’ logical operator. Another exemplary value for L could be L=10. The FEC symbol errors fe(m) can now be used to construct metrics which are indicative of and well correlated to post-FEC BER performance.

From the FEC symbol error stream fe(m), the DNN-based estimation system 102 can compile and generate the histogram or probability density function (PDF) statistics of the probability of occurrence of the number of FEC symbol errors in a given FEC codeword of size Nfec from a set of FEC symbol error measurements spanning Ncw codewords. A codeword histogram (CWH) is essentially a mapping between the number of FEC symbol errors in a given codeword of size Nfec and the probability of occurrence for that many FEC symbol errors. In a tabular format an example of such a codeword histogram could be as follows in Table 1:

TABLE 1
Example of Codeword Histogram

| Number of FEC Symbol Errors in | Probability of Occurrence |
|---|---|
| Codeword of Length Nfec (i) | hm(i, ber) |
| 0 | 0.889 |
| 1 | 1e⁻¹ |
| 2 | 1e⁻² |
| 3 | 1e⁻³ |
| 4 | 0 |
| 5 | 0 |
| and so on . . . | 0 |

Let us denote such a measurement based histogram as hm(i,ber) where i represents the index of how many FEC symbol errors there are (first column of Table 1) and ber represents the pre-FEC BER at which the codeword measurements were taken. Also, let hml(i,ber) represent the logarithm base10 of the corresponding measured histograms in the following Equation 3:

$${h}_{ml} ( i , ber ) = {log}_{10} ( {h}_{m} ) \qquad ( Equaiton 3 )$$

### Approximate Codeword Histograms (CWH)

The baseline codeword histogram deviation metric is obtained from a measured codeword histogram which in turn is obtained from measured FEC symbol errors fe(m) and the underlying bit errors e(n) as described previously. To obtain the underlying true bit errors e(n) assumes an ability to compare the received detected bits with the corresponding transmitted bits. This is typically accomplished in a training mode where the transmitter is transmitting a pattern, such as a PRBS pattern, known to both the transmitter and receiver. However, it is also highly desirable to be able to obtain codeword histograms without having to transmit a training pattern, i.e., be able to compute the histogram when the transmitter is transmitting live user data not known to the receiver.

Towards this goal, it is possible to directly obtain an approximate measurement of the FEC symbol error statistics by using information from the FEC decoder itself. Upon receiving a codeword from the SerDes, the FEC decoder will take one of three possible actions: (i) correct some number of FEC symbol errors in that codeword at the correct error locations in the received codeword; (ii) not make any correction attempt when there were no errors in the received codeword; (iii) not make any correction attempt when there were errors in the received codeword; or (iv) perform a mis-correction (i.e., it is unable to correct all the actual FEC symbol errors in the received codeword and may attempt to correct one or more FEC symbols not corresponding with the actual FEC symbol error locations in the codeword). The third and fourth scenarios are obviously undesirable, with the fourth scenario actually being harmful. However, FEC theory suggests that the probability of the last two scenarios occurring are significantly lower than that of the first two scenarios and thus negligible for many FEC codes. The higher the correction capability of the FEC code, the lower is the probability for the undesirable scenarios. Thus, simply by examining the number of FEC symbol error corrections per codeword, fdec_corrcw(r) for the rth codeword, attempted by the FEC decoder and considering them to be the actual number of FEC symbol errors in the received codeword, the DNN-based estimation system 102 can generate an approximate measured histogram which for the sake of technical accuracy is denoted as hma(i,ber) to distinguish it from hm(i,ber), which is the measured histogram derived from the true FEC symbol error stream which would have been obtained with a training pattern. The log₁₀ version of this is denoted by Equation 4:

$${h}_{mal} ( i , ber ) = {log}_{10} ( {h}_{ma} ) \qquad ( Equation 4 )$$

It should be noted that in scenarios (i) and (ii) fdec_corrcw will correspond to the true number of FEC symbol errors per codeword whereas in scenarios (iii) and (iv), it will not. However, as noted earlier, the probability of scenarios (iii) and (iv) is typically very small compared with the probability of scenarios (i) or (ii). In subsequent block diagrams, the codeword histograms will be generically denoted by the abbreviation ‘CWH’.

### Burst Histograms (BURH)

A burst histogram represents the probability of a burst of a certain length occurring as opposed to the probability of a certain number of errors within a fixed codeword length, i.e., it is the probability of having a certain number of consecutive FEC symbols in error. For example, consider an error event in units of FEC symbols such that a ‘E’ represents an error in the FEC symbol and a ‘0’ represents no errors in the FEC symbol. An isolated FEC symbol error, i.e., an isolated ‘E’ with no other errors in the vicinity, can be represented as ‘ . . . 0000E0000 . . . ’ and represents a burst length of 1. An error event of the form ‘ . . . 0000EE0000 . . . ’ represents a burst of length 2 and so on. In a tabular format an example of such a codeword histogram could be as follows in Table 2:

TABLE 2
Example of Burst Histogram

| Number of Consecutive FEC Symbol Errors | Probability of |
|---|---|
| Across Simulation / Measurements | Occurrence hm(i, ber) |
| 0 | 0.889 |
| 1 | 1e⁻¹ |
| 2 | 1e⁻² |
| 3 | 1e⁻³ |
| 4 | 0 |
| 5 | 0 |
| and so on . . . | 0 |

In addition, it may be useful to consider an error free interval (EFI) to consider burst error events in a more pessimistic manner. For example, the event ‘ . . . 0000E0E . . . ’ would normally be considered to be comprised of two bursts of length l each. If we are more pessimistic about this (which may be justified in links with highly correlated errors), then with an EFI=1, the same error event would be designated as having a single burst length of 3. Likewise, with an EFI of 2, an event such as ‘ . . . 0000E00E0000 . . . ’ would be considered to have a burst length of 4. In subsequent block diagrams, the burst histograms will be generically denoted by the abbreviation ‘BURH’.

### SNR Histograms

The following describes SNR histograms for training a DNN. In at least one embodiment, a SerDes transmitter (TX) (e.g., transmitter circuit 120) typically transmits a binary data sequence, modulates it with a pulse amplitude modulation (PAM) format such as PAM2 (two amplitude levels) or PAM4 (four amplitude levels). These are example modulation formats; others can be considered. The modulated sequence may be equalized with transmit equalization and sent through the communication channel 124, followed by a SerDes receiver (RX) equalizer (e.g., receiver circuit 122) to produce a received equalized output y(n), which may be equalized to a non-return to zero (NRZ) target or to a partial response (PR) target. If transmitting a known pseudo-random binary sequence (PRBS) through the link (communication channel 124), a received error signal errtrue(n) can be computed with respect to the known transmitted bits converted to the corresponding equalized/modulated signal ytx(n), as expressed in Equation 5:

$$errtrue ( n ) = y ( n ) - ytx ( n ) \qquad ( Equation 5 )$$

If a known PRBS sequence is not used, the SerDes RX can still compute a received detected error signal, errdet(n), using a sliced or data detected estimate of ytx(n), which is called here ydet(n), as expressed in Equation 6:

$$errdet ( n ) = y ( n ) - ydet ( n ) \qquad ( Equation 6 )$$

The traditional nominal SNR metric SNRnom is typically computed using the variance of the measured or detected error over a large number of samples as in the following Equation 7:

$$errdetvarnom = \frac{1}{K} {\sum }_{n = 1}^{K} errdet {( n )}^{2} \qquad ( Equation 7 )$$

where K is typically a very large number to achieve good averaging, for example, 1e⁵, 1e⁶, or more equalized samples. For simplicity, the expression above for the variance is based on assuming a nominally zero mean error sequence, be it errtrue(n) or errdet(n). This will be the case in most systems, especially those which have explicit hardware/circuits to remove any non-zero DC mean. As is well known in the engineering community, a more general expression for the variance can remove the impact of any non-zero mean with only minor changes, as expressed in Equation 8:

$$errdetvarnom = \frac{1}{K} {\sum }_{n = 1}^{K} {( errdet ( n ) - errdetmn )}^{2} \qquad ( Equation 8 )$$

where errdetmn is the mean of the errdet(n) sequence and can be computed as follows in Equation 9:

$$errdetmn = \frac{1}{K} {\sum }_{n = 1}^{K} errdet ( n ) \qquad ( Equation 9 )$$

However, for the sake of simplicity only, the simpler expression for variance computations is used throughout this disclosure. It should be understood that any of the subsequent expressions for variance could be modified to properly account for a non-zero mean.

If the nominal signal power in the transmitted signal power or received equalized signal is denoted as sigvar, then the SNRnom is traditionally computed as follows in Equation 10:

$$SNRnom ( dB ) = 10 * log 10 ( sigvar / errdetvarnom ) \qquad ( Equation 10 )$$

The signal power can be computed from the set of expected equalized signal values whose values will be from the set of values for ytx(n) or ydet(n). For example, for a PAM4 modulated system with transmitted symbol values of 3, 1, −1, −3, the nominal signal power can be computed as follows in Equation 11:

$$sigvar = ( 1 / 4 ) * ( 3 \hat{} 2 ) + ( 1 / 4 ) * ( 1 \hat{} 2 ) + ( 1 / 4 ) * ( ( - 1 ) \hat{} 2 ) + ( 1 / 4 ) * ( ( - 3 ) \hat{} 2 ) = 5 \qquad ( Equation 11 )$$

In the expression, the factors of (¼) represent the probability of occurrence for each possible PAM4 symbol value. For a partial response (PR) equalized system, the signal variance can be computed based on the received expected PAM4 PR symbols. For example, for a (1+D) PR1 system, the PAM4PR1 system symbol values will be 6, 4, 2, 0, −2, −4, −6 and sigvar can be computed in a similar fashion, accounting for the probability of occurrence of each specific symbol value.

Having described the SNR calculation, it can be observed that using a single number, such as described above, does not provide adequate insight into or always correlate well with post-FEC performance behavior. As such, SNR metrics taken from an SNR histogram can be considered where each SNR value measured is defined over a window of time, L. From multiple such measured SNR values, a measured SNR histogram can be obtained over those multiple SNR values and compute an SNR deviation histogram with respect to some target SNR histogram. Exemplary values of L could be in the hundreds or thousands of equalized samples, chosen appropriately depending on the application. Over the time window of L received PAM2 or PAM4 (or other) modulated symbols or corresponding equalized samples, a statistical variance or equivalently, a standard deviation of these error quantities can be computed as expressed in Equation 12 and Equation 13:

$$errtruevar = \frac{1}{L} {\sum }_{n = 1}^{L} errtrue {( n )}^{2} \qquad ( Equation 12 )$$

$$errdetvar = \frac{1}{L} {\sum }_{n = 1}^{L} errdet {( n )}^{2} \qquad ( Equation 13 )$$

If the nominal signal power in the transmitted signal power or received equalized signal (it is not critical which one is used) is denoted as sigvar then the SNR for the above error variants are denoted as follows in Equation 14 and Equation 15:

$$SNRTRUE ( dB ) = 10 * log 10 ( sigvar / errtruevar ) \qquad ( Equation 14 )$$

$$SNRDET ( dB ) = 10 * log 10 ( sigvar / errdetvar ) \qquad ( Equation 15 )$$

It should be noted that the SerDes RX may transfer raw error data, such as errtrue(n) or errdet(n), to the DNN-based estimation system 102, and the DNN-based estimation system 102 may compute the SNR and SNR histograms. Alternatively, the SerDes hardware may compute the SNR metrics internally using appropriate hardware blocks to realize Equation 14 and Equation 15, and the SNR data can be sent to the DNN-based estimation system 102.

It may be beneficial for the value of L to be related to the FEC codeword size. In an exemplary system with the well-known code (Nfec=544, Kfec=514, Tfec=15) defined over a Galois field of 10 bits, the codeword size is 544 FEC symbols or 5440 bits, which for a PAM4 system is 2720 PAM4 symbols since each PAM4 symbol is comprised of 2 bits. Thus, a value of L=2720 may be desirable.

From the SNRTRUE or SNRDET data, the DNN-based estimation system 102 can compile and generate the histogram or probability density function (PDF) statistics of the probability of occurrence of the various measured SNR values. An SNR histogram is essentially a mapping between the SNR value over window L and the probability of occurrence for that SNR value.

For example, the DNN-based estimation system 102 can denote a measurement-based histogram as hsNR(SNRi), including possible measured values of the SNR (be it SNRTRUE or SNRDET), where i is an index which indexes a list of SNR values over which the histogram is computed. For example, a histogram could be computed over a range of SNRmin=14 to SNRmax=24 dB in steps of SNRstep=0.1 dB, representing a list of say Q SNR values which would be indexed by i=1 to 101, where in this example Q=101. From many measurements of the SNR across, for example, NSNR=10000 measurements, the DNN-based estimation system 102 can compute the measured SNR histogram. Each of these measurements consists of L individual measurements of the equalized error errtrue(n) or errdet(n) to obtain the errtruevar or errdetvar as previously described. Now suppose the SNR value of 19.2 dB occurs 10 times. For the above example of 14 to 24 dB with steps of 0.1 dB, the value 19.2 dB corresponds with index of i=53. Then the probability assigned to the 19.2 dB at index i=53 in the histogram is 10/NSNR=1e⁻³.

Also, let hSNRL(SNRi) represent the base-10 logarithm of the corresponding measured and target codeword histograms as in the following Equation 16:

$$hSNRL ( SNRi ) = log 10 ( hSNRi ) \qquad ( Equation 16 )$$

In the case of interleaving, we need to modify the calculation of the SNR to account for interleaving as follows. In the following, we refer to computations using the true error (errtrue) or the detected error (errdet) using the generic variable err and likewise for their corresponding SNRs using the generic variable SNR to represent either SNRtrue or SNRdet. Let us consider a window of M PAM4 symbols which comprise one FEC symbol. For example, for a well-known FEC code (Nfec=544, Kfec=514, Tfec=15) defined over a Galois field of 10 bits, the FEC symbol size is 10 bits. Thus we would choose M=5 since each PAM4 symbol consists of 2 bits.

$$errvarfsym = \frac{1}{M} {\sum }_{n = 1}^{M} {err ( n )}^{2} \qquad ( Equation 17 )$$

$$SNRFSYM ( dB ) = 10 * log 10 ( sigvar / errvarfsym ) \qquad ( Equation 18 )$$

We now pass the sequence of SNRFSYM values through the equivalent of the RS de-interleaver function RSILD such that individual SNRFSYM values are manipulated in the same way as a FEC symbol errors would be through a de-interleaver as illustrated in FIG. 3. The output of this manipulation results in a deinterleaved SNR denoted as SNRFSYMIL which reflects the properties of the deinterleaver and will correlate well with post-FEC bit error rate performance accounting for the deinterleaver behavior. This equivalent RSILD functionality may be implemented in hardware or software. Of course, it will be designed differently from a straight RSILD block which operates on integer FEC symbols or FEC symbol errors. From the SNRFSYM we can now compute a windowed or averaged SNR post-interleaving as set forth in Equation 19:

$$SNRIL = \frac{1}{K} {\sum }_{l = 1}^{K} SNRFSYMIL ( l ) , \qquad ( Equation 19 )$$

where K represents the windowing span. To equivalently match the prior window of L for the non-deinterleaved case, for example K could have a value of L/M which implies that our effective averaging window is L=K*M. SNR histograms would now be computed using SNRIL.

In at least one embodiment, the DNN-based estimation system 102 can receive the equalized error data from the receiver circuit 122. In at least one embodiment, the receiver circuit 122 (SerDes RX) also typically has an associated pre-FEC SNR which can be characterized. A nominal SNR, SNRnom, can be measured by taking the variance of a large number of equalized error samples and is mainly reflective of pre-FEC performance and pre-FEC BER. In at least one embodiment, the DNN-based estimation system 102 can receive SNR data from the receiver circuit 122. The DNN-based estimation system 102 can determine an SNR histogram (and a related post-FEC correlated performance metric) using equalized error data (or the SNR data) received from the receiver circuit 122. The DNN-based estimation system 102 can adapt encoding/decoding layer parameters (FEC-related parameters) and/or SerDes parameters using the SNR histograms (and related post-FEC correlated performance metric). The DNN-based estimation system 102 can collect and process this data as part of DNN training. Once the DNN is trained, this data may not necessarily be collected and processed as part of DNN inference.

In at least one embodiment, the DNN-based estimation system 102 can adapt (i) FEC-related parameters, such as the interleave factor, to optimize post-FEC BER performance through the use of a post-FEC BER estimation obtained by a trained DNN. In at least one embodiment, the DNN-based estimation system 102 can adapt (ii) link parameters 1740, such as SerDes parameters, to optimize post-FEC BER performance through the use of a post-FEC BER estimation obtained by a trained DNN. As described above, different post-FEC correlated performance metrics, also referred to as adaptation metrics, can be based on (i) SNR histogram data, (ii) codeword histogram data, or (iii) burst histogram data.

In subsequent block diagrams and description, the SNR histograms based on SNR or SNRIL will be generically denoted by the abbreviation ‘SNRH’.

### Traditional Post-FEC BER Estimation Techniques

FIG. 4 are block diagrams of three high-level types of post-FEC BER estimation techniques according to various implementations.

### Post-FEC BER Estimation Based on the ‘Random’ Binomial Model

A classical model to compute the post-FEC BER requires cognizance of only the pre-FEC BER and the FEC codeword size to estimate the post-FEC BER. However, this model assumes that the errors are random and not correlated, and a binomial probability distribution is assumed to compute post-FEC BERs. As such, it will not yield accurate post-FEC BER estimates to channels/links which have correlated or burst errors, including links where the SerDes RX is equalized to a partial response and/or makes use of precoding or concatenated codes in addition to the RS FEC.

### Post-FEC BER Estimation Based on Multi-Nomial Model and Variants

Other post-FEC modeling/estimation techniques in the literature attempt to account for correlation in the FEC symbol errors using a ‘multi-nomial’ type of models. These models, which comprise of an underlying set of multi-nomial probabilities, make use of the codeword histograms (CWH) or the burst histogram (BURH). Codeword histograms can be measured directly from transient simulation and/or silicon data. Likewise, burst histogram data for a given EFI can also be measured directly from transient simulation and/or silicon data as per the definition and description above. It can also be extracted from the codeword histogram data. The codeword histograms or burst histograms and the pre-FEC BER can be fed into a semi-analytic model, along with the corresponding FEC parameters. The semi-analytic model determines the post-FEC BER estimation. The flow of such post-FEC BER estimation techniques is shown in the first two diagrams of FIG. 4.

### Post-FEC BER Estimation Based on SNR Histograms

In at least one embodiment, another post-FEC modeling estimation technique includes using SNRH, as described above. In this embodiment, SNR histograms can be measured directly from transient simulation and/or silicon data. This data can be collected for different FEC parameters. The SNRH and the pre-FEC BER can be fed into a semi-analytic model, along with the corresponding FEC parameters. The semi-analytic model determines the post-FEC BER estimation. The last diagram in FIG. 4 shows such an SNR histogram-based flow for post-FEC BER estimation.

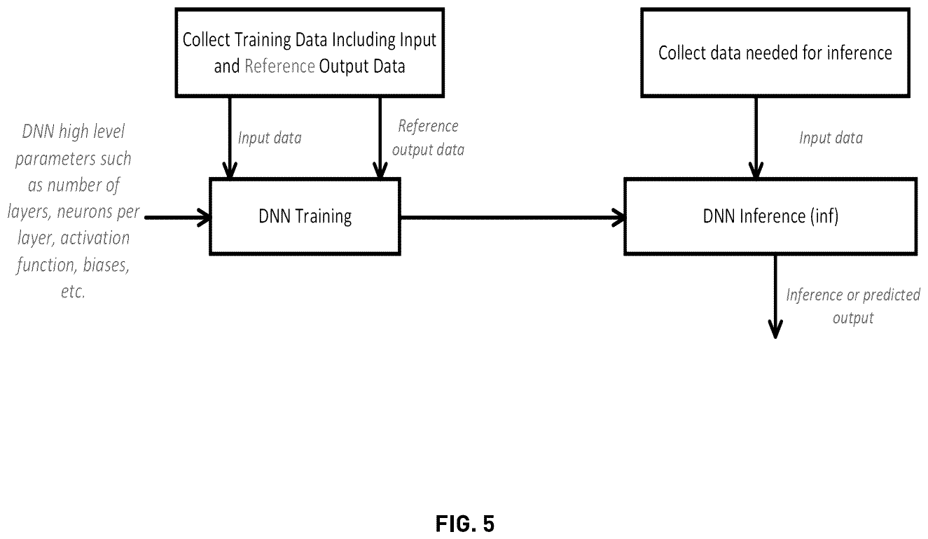

FIG. 5 is a block diagram of a DNN training and DNN inference architecture according to at least one embodiment. In this architecture, a DNN is used to predict post-FEC BER as the desired output. The DNN-predicted post-FEC BER can be used to adapt FEC-related parameters and/or link parameters (i.e., SerDes parameters).

A DNN model takes certain input data and reference output data such that upon training, the DNN is able to create a model for the relationship between the input data and reference output data. Once the model has been trained, it can be used for inference or prediction to take some new set of input data and predict the corresponding output data using the DNN model. There are various generic training algorithms which are available for public use. For the embodiments described herein, the output reference data and predicted output data are post-FEC BER for communication links. The input data with which the DNN is trained and new input data which is used to infer post-FEC BER data may vary depending on the formulation of the algorithm.

### Generalized DNN Training and Inference Based on Channel Properties, Link/SerDes Properties, Channel/Receiver Impairment Properties

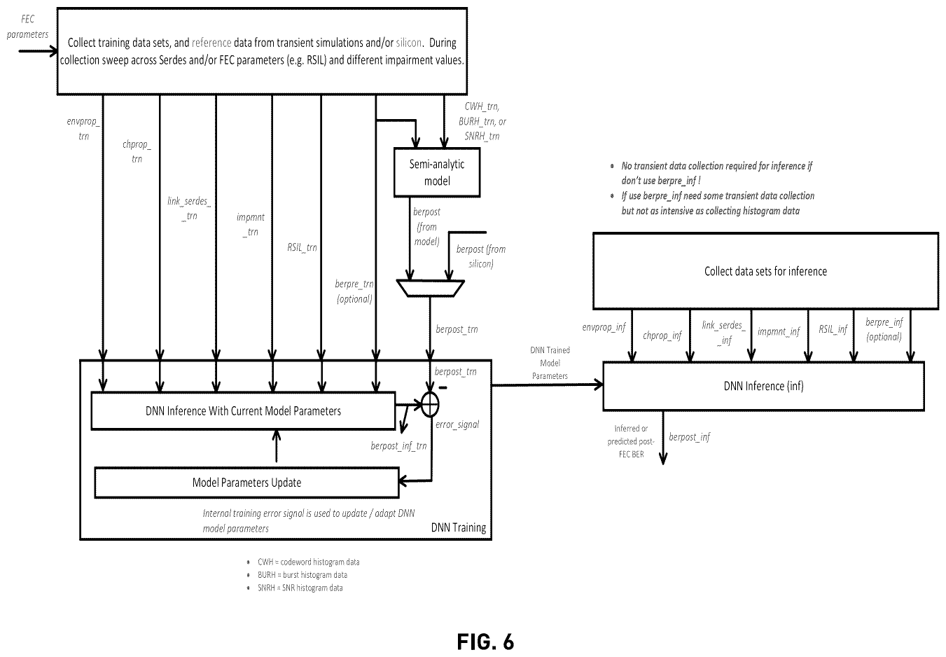

FIG. 6 is a block diagram of a post-FEC BER estimation architecture using DNN based training according to at least one embodiment.

The post-FEC BER performance of a communication link/channel has a complex dependence on the properties of the channel and the many impairments in the system. The block diagram of FIG. 6 shows the overall architecture for training and inference in our proposed system. Data is collected via transient simulations to generate codeword histogram, burst histogram, or SNR histogram depending on which semi-analytical model type is used for the training phase for post-FEC BER estimation. The histogram data may also be collected from silicon, and if post-FEC BER data is available in silicon, it may also be collected as such. From the semi-analytic model or silicon data, we note the post-FEC BER denoted as berpost_trn. We also characterize the environmental properties where the SerDes and channel are operating in, selected link/SerDes properties/settings, and key impairment properties for the link being considered. The collection of environmental, channel, link/SerDes, and impairment properties, denoted generically as envprop_trn, chprop_trn, link_serdes_trn, and impmnt_trn, are also recorded optionally with the corresponding pre-FEC BER, berpre_trn, and interleaving factor, RSIL_trn. All this information is collected and recorded over a large aggregate collection of links and used to train a DNN model such that the DNN model's goal is for its output to match berpost_trn as closely as possible. The input layer of the DNN will consist of as many parameters as needed to characterize the channel, link/SerDes, and impairment values, optionally with berpre_trn and RSIL_trn. The output layer consists of a single neuron whose output value represents the post-FEC BER. Inside the training block, we show some additional implicit details. The training will start with some initial DNN model parameters, which will be used to infer the interim post-FEC BER during training, denoted as berpost_trn_inf. A training error signal will be computed between this interim berpost_trn_inf value and the reference berpost_trn value, and the error signal will be used to update/adapt the DNN model parameters. Subsequent figures omit these details of the DNN training block.

### Example Environmental Properties for Training/Inference

Operating temperature for the SerDes, channel, or other link components
Operating voltage of the channel, link components, transmitter SerDes, receiver SerDes
Nominal manufacturing process corner (e.g., slow/nominal/fast) of the transmitter SerDes, receiver SerDes

### Example Channel Properties Used for Training/Inference

Channel through path (signal transmission path as opposed to crosstalk or other impairment paths) loss at one or more frequencies, such as the Nyquist frequency, half-Nyquist frequency, or others.
Channel through impulse response values. For multi-part optical links, the response could be an aggregate of all the individual component responses including optical components such as the optical module transmitter response, optical fiber transmission response, or optical transimpedance amplifier (which converts light to current) response.
Channel S-parameters—these represent the most comprehensive and detailed representation of channel properties and account for both through responses, cross talk responses, differential to common mode conversion, and common mode to differential conversion.

### Example Link/SerDes Properties or Settings Used for Training/Inference

Transmit optical link power for optical links
Other optical module settings such as equalization/gain values
TX SerDes launch amplitude
RX SerDes ADC full scale voltage for RX SerDes
TX or RX PLL phase noise control (e.g., different PLL controls may offer different tradeoffs between SerDes power and phase noise properties whose low frequency characteristics can significantly affect post-FEC behavior).
RX AFE noise control (e.g., different RX AFE controls may offer different tradeoffs between SerDes power and AFE bandwidth or output noise)

### Example Impairment Properties

Crosstalk aggregate noise root mean square (r.m.s.) or standard deviation value. For multi-part optical links, multiple r.m.s values of the crosstalk for each link section would be used.
Crosstalk impulse responses
Crosstalk S-parameter responses
Transmitter noise r.m.s or standard deviation value
Transmitter noise power spectral density profile (noise magnitude vs. frequency)
Transmitter jitter components in terms of r.m.s. values, peak to peak values, or phase noise profiles depending on the component.
Receiver noise power spectral density profile (noise magnitude vs. frequency)
Receiver noise r.m.s or standard deviation value
Receiver jitter components in terms of r.m.s. values, peak to peak values, or phase noise profiles depending on the component.
For optical links, optical transmitter module noise r.m.s. or standard deviation value
For optical links, optical transmitter module noise power spectral density profile (noise magnitude vs. frequency)
For optical links, fiber properties such as responsivity frequency profile
For optical links, optical receiver transimpedance amplifier noise r.m.s. or standard deviation value
For optical links, optical receiver transimpedance amplifier noise power spectral density profile (noise magnitude vs. frequency)
Other transmitter and receiver impairments characterized in various forms such as r.m.s. value, peak to peak value, power spectral densities, etc. Impairments could consist of transmitter digital to analog converter (DAC) quantization effective number of bits (ENOB), receiver analog to digital converter (ADC) ENOB, clock data recovery (CDR) self-jitter, residual voltage offsets in various points in the receiver, or residual gain mismatches in various points in the receiver, residual phase mismatches in various points in the receiver.
Channel common mode to differential mode conversion factor at one or more frequencies or common mode to differential mode frequency response profile.
Channel differential to common mode conversion factor at one or more frequencies or common mode to differential mode frequency response profile. Note that the use of channel S-parameters in lieu of through impulse responses may automatically capture some of the channel-related impairments such as channel common mode to differential mode conversion or vice-versa.

### Use of Optional Pre-FEC BER

Using the pre-FEC BER during training and inference may improve the accuracy of the overall estimation process. The use of pre-FEC BER during inference does require some transient data collection, be it from simulation or silicon. However, this data collection effort is significantly less intensive than that required to collect codeword, burst, or SNR histograms. However, if the list of channel properties and impairment properties is comprehensive enough, the use of pre-FEC BER may not be needed at all and thus is considered optional. In this scenario, no transient data collection is required during the inference process to estimate berpost_inf.

### Use of Subsets of Impairment

Note that the number of impairments used for training/inference need not be the total full set of impairments present. Some impairments might be excluded from the list if experience or other theoretical considerations show they impact post-FEC BER less or if the subset of impairments are such that they do not vary across all the link training/inference possible cases. For example, ADC ENOB may not vary significantly across link cases and corresponding TX/RX settings invoked by the link and possibly could be excluded.

### Delta Post-FEC BER Approach to Training and Inference

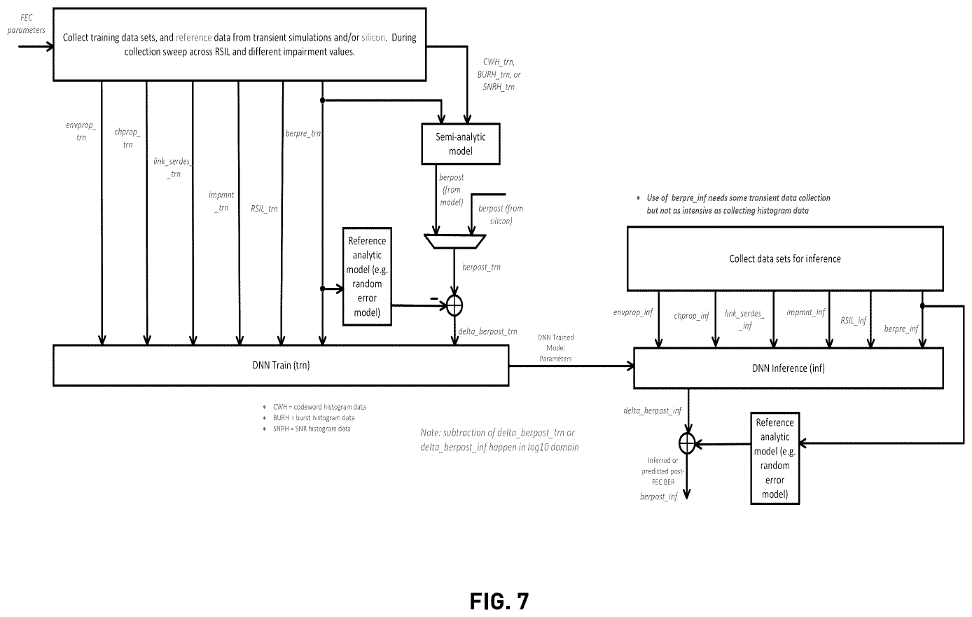

FIG. 7 is a block diagram of an alternative architecture for post-FEC training and inference according to at least one embodiment. The architecture is used to train and infer what we call a ‘delta post-FEC BER’. This delta post-FEC BER is the difference (in log 10 domain) between the post-FEC BER predicted by the semi-analytic model for a given channel and the post-FEC BER predicted by some other reference analytic model, with both models operating on data for the same pre-FEC BER. An example reference model is the pure random error model behavior, as determined solely by the pre-FEC BER for that channel. The random error model is well known in the literature and is based on a binomial random probability distribution of the FEC symbol error statistics. With this approach, instead of training on the post-FEC BER, which can vary over a much wider dynamic range, we train over the delta post-FEC BER, which can have a smaller dynamic range, and thus its prediction efficacy may be facilitated or possibly performed with simpler DNN models. Once we have obtained the trained DNN model during the inference process, instead of directly inferring or predicting the post-FEC BER, we infer the delta post-FEC BER and then add it to the corresponding random error model post-FEC BER for the same pre-FEC BER. The output of the subtraction gives us the final inferred or predicted post-FEC BER. The subtraction/addition operations are, of course, performed in the log 10 domain.

Also, the random error model need not be the only possible reference model. It is possible other analytic models, such as Markov chain based analytical models, could be used as reference models.

### Top Level System Block Diagrams Incorporating DNN Training and Inference

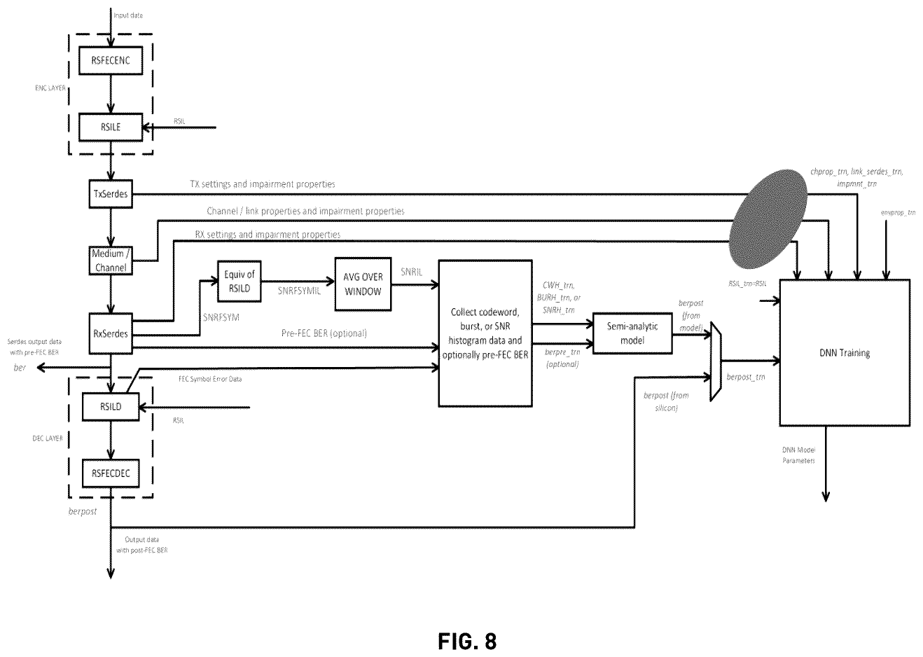

FIG. 8 is a block diagram of an overall link/SerDes/FEC architecture incorporating DNN based training according to at least one embodiment. It should be noted that various channel properties, link properties, TX SerDes settings, impairment properties, and RX SerDes settings are aggregated into the generic variables chprop_trn, link_serdes_trn, and impmnt_trn.

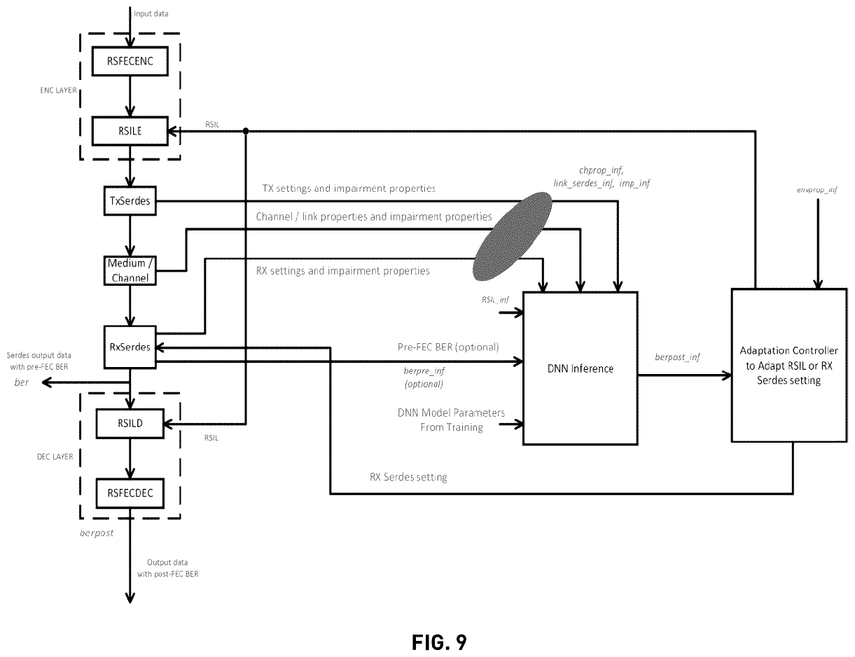

FIG. 9 is a block diagram of an overall link/SerDes/FEC architecture incorporating DNN based inference according to at least one embodiment. The architecture shows the DNN based inference/post-FEC BER estimation once the DNN based training of FIG. 8 is completed. The DNN model parameters of FIG. 9 would be populated using the final trained model values from FIG. 8. We also show that the estimated post-FEC BER can be used to adapt the FEC interleaving factor RSIL or, for example, a particular RX SerDes setting. This can be performed by using a grid search of inferring post-FEC BER across different RSIL values or RX SerDes setting values. One could choose the optimal value of RSIL or SerDes RX setting or choose the RSIL or SerDes RX setting at which increasing RSIL or changing the RX setting does not result in significant further improvement in post-FEC BER.

### Alternative Training/Inference Framework

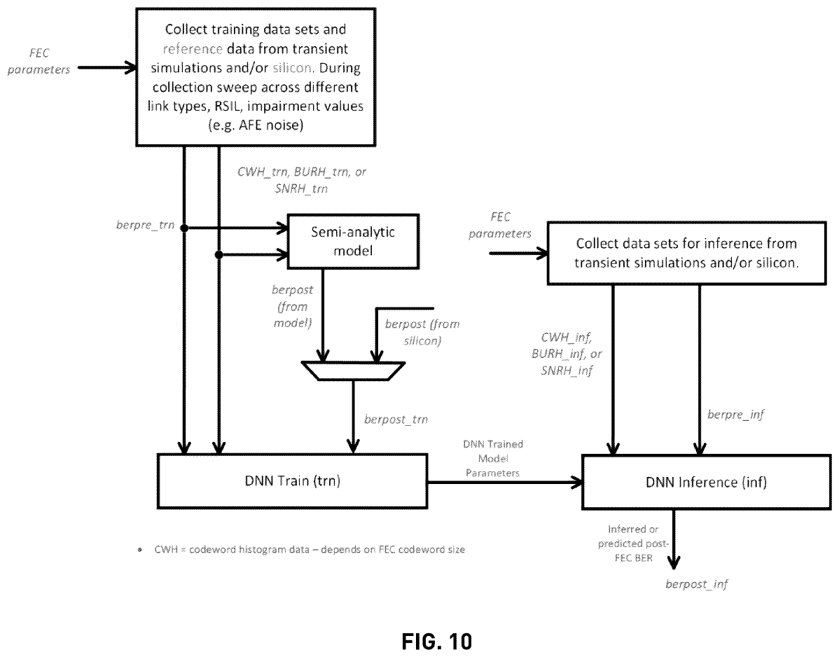

FIG. 10 is a block diagram of an alternative framework for training/inference according to at least one embodiment. In this framework, we train the DNN model only with the pre-FEC BER and either codeword histogram, burst histogram, or SNR histogram information collected from transient simulation or silicon data. During training, we will try obtaining as much silicon provided data as possible for the post-FEC BER reference data for medium and higher impairment values. During the inference phase, collect codeword histogram, burst histogram, or SNR histogram data and pre-FEC BER data, and use the DNN model to estimate the post-FEC BER. Compared with the more generalized framework of FIG. 6, there is no savings of data collection requirements during the inference phase. However, compared with the prior solutions, we are reducing our dependence on the use of the semi-analytical model to obtain post-FEC BER for medium and higher impairment values. Also, the accuracy may be better than the more generalized approach since histograms are used directly for inference and training, and is not based on channel/impairment properties but solely based on the histogram data.

Periodic DNN Training and/or Inference for Post-FEC BER Estimation and Adaptation

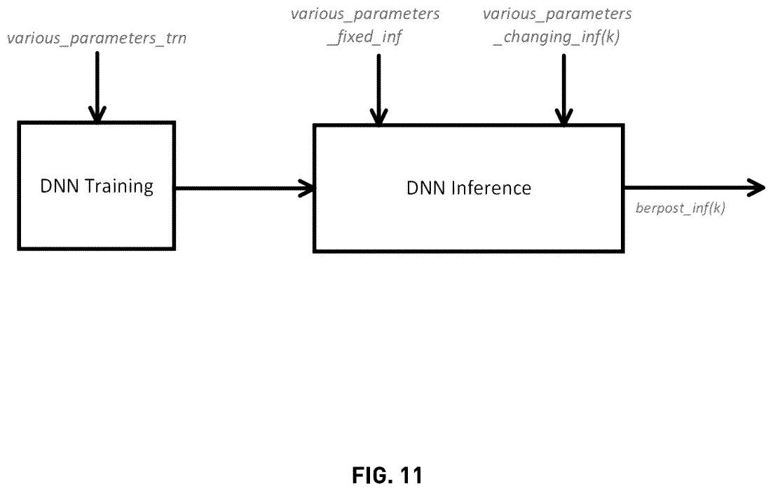

The discussion thus far may suggest that once DNN training is accomplished, we then estimate post-FEC BER one time for a given link based on DNN inference. In practice, we can periodically perform DNN training and/or DNN inference. For example, after performing training and then estimating post-FEC BER through inference for a particular link, the environmental temperature may have changed. We can then periodically compute the post-FEC BER using inference, keeping all other inference parameters the same as before while only changing the temperature parameter. An example of this periodic inference is shown in FIG. 11, where the variable k represents the time period at which post-FEC BER is re-inferred.

FIG. 11 is a block diagram illustrating periodic inference while keeping some parameters from inference fixed while varying other inference parameters, where k represents the time period at which post-FEC BER is re-inferred according to at least one embodiment.

For example, we could set k to be 24 hours such that the post-FEC BER is re-inferred/estimated once every day with the new environmental temperature being updated for the re-inference. This can be done periodically without retraining the DNN. Only if some environmental conditions have changed, which exceeds the ranges established during the original training phase, would we have to retrain the DNN. This could still be done as long as we collect new relevant data and retrain. For example, suppose initial training was performed in the range of −40 degrees Celsius to 75 degrees Celsius. If the device temperatures exceed 75 degrees Celsius to 100 degrees Celsius, inference based on the prior DNN model parameters may no longer be accurate. We would need to retrain the DNN for higher temperatures and ensure that if any training parameters (e.g., receiver noise) significantly change for the higher temperature, we provide the corresponding proper values of the relevant training parameters for DNN training.

### DNN Training Guardrails

In order to work with a training set which will produce sensible model parameters and more consistent predicted post-FEC BERs during inference, we can consider some filtering criteria for the training data set to ensure it does not contain anomalous cases, such as a SerDes receiver whose equalization/clock data recovery is not stable or behaving as expected in a well-designed system. Also, depending on the semi-analytic model used, it is possible that due to scarce available data or numerical issues, the semi-analytical model post-FEC estimated BER during training could be noisy or non-monotonic for a particular link/channel where the impairment is swept in a monotonically increasing value. Examples of such guard-railing criteria to filter out bad training data could be:
Whether or not the SNR histograms are used for the semi-analytic model, ensure that SNR histograms are not multimodal but have a single well-defined peak. Multimodal SNR histograms may be indicative of receiver equalization or clock data recovery drift.
Ensure that codeword histograms are sufficient in length before use in the semi-analytic model. For example, if only 1 or 2 bins are observed in the data, do not use.
Ensure that codeword histograms do not have large ‘holes’, e.g., a codeword histogram with non-zero probability bins for lower values, followed by one or more bins without data, and then again followed by non-zero probability bins.
For a given link, if there is monotonically swept impairment data, ensure that the semi-analytic model provides monotonic outputs and potentially discard any data which deviate significantly from the post-FEC BER vs. impairment value average trend line, or replace such deviating data with data corresponding with the average trend line.

### Variations

The DNN-based post-FEC BER estimation and adaptation system has primarily utilized a single Reed-Solomon (RS) FEC encoder and decoder. Other types of encoder/decoder combinations are also possible.

It is possible to have a concatenated FEC system such as an RS encoder/interleaver followed by a BCH encoder/interleaver on the encoding/transmit side, and an RS deinterleaver/RS decoder preceded by a BCH deinterleaver/BCH decoder on the decoding/receive side.
The block diagram of FIG. 9 shows adaptation of the RS interleaving parameters. Other FEC or SerDes parameters could be adapted as well if their values are properly incorporated into both the training and inference phases of system operation.

For SerDes parameters, a judicious choice of parameters for adaptation using a DNN-based adaptation flow is important. For example, it would make sense to adapt only major parameters that are not easily amenable to traditional adaptation methods, such as a least mean squared adaptation algorithm.
The adaptation block diagram of FIG. 9 could be appropriately modified to work with the delta post-FEC BER estimation approach as well.

Although indicated in the block diagram, it is explicitly noted here that data collection during the training phase can be performed using a hybrid approach with a mix of silicon-obtained post-FEC BER reference data and semi-analytic model-obtained post-FEC reference data. Non-zero post-FEC BER data from silicon can be available at higher noise levels or other higher impairment values, with such higher impairment values applied to the link either via external stimuli or potentially self-generated SerDes impairments. At lower impairment levels, since even silicon may not be able to produce non-zero post-FEC BER data in a reasonable time, codeword histogram or SNR data would have to be collected from silicon, and reference post-FEC BER data generated from the histogram data using one or more semi-analytic models.

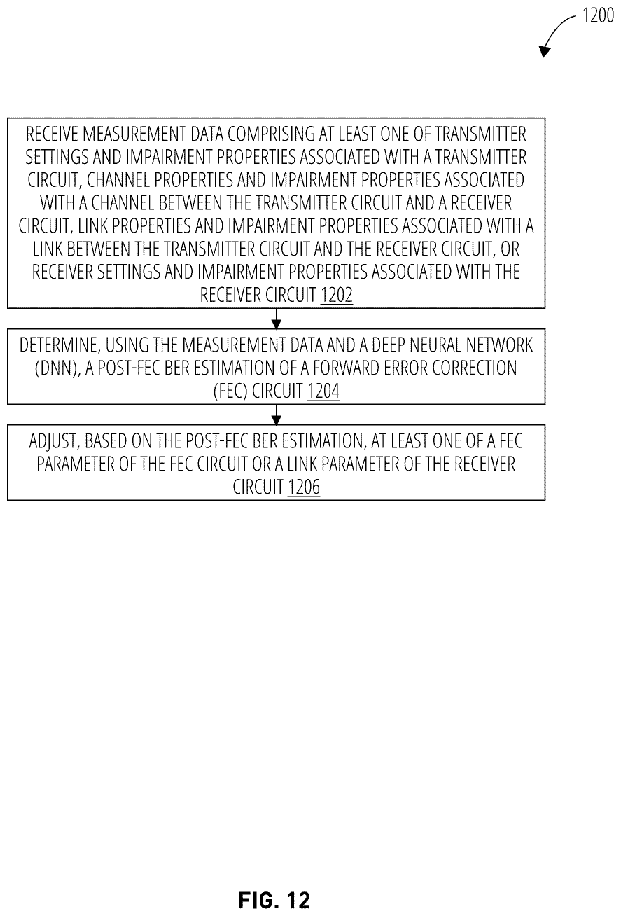

FIG. 12 is a flow diagram of an example method 1200 for determining a post-FEC BER estimation using a DNN according to at least one embodiment. Method 1200 can be performed using one or more processing units (e.g., CPUs, GPUs, accelerators, physics processing units (PPUs), data processing units (DPUs), etc.), which may include or communicate with one or more memory devices. In at least one embodiment, the method 1200 can be performed by a processing device or devices. processing devices. In at least one embodiment, the method 1200 can be performed using processing units of DNN-based estimation system 102 of FIG. 1 or FIG. 2. In at least one embodiment, method 1200 can be performed by DNN-based estimation system 102 of FIG. 2. In at least one embodiment, processing units performing the method 1200 can be executing instructions stored on a non-transitory computer-readable storage media. In at least one embodiment, the method 1200 can be performed using multiple processing threads (e.g., CPU threads and/or GPU threads), with individual threads executing one or more individual functions, routines, subroutines, or operations of the method. In at least one embodiment, processing threads implementing the method 1200 can be synchronized (e.g., using semaphores, critical sections, and/or other thread synchronization mechanisms). Alternatively, processing threads implementing the method 1200 can be executed asynchronously with respect to each other. Various operations of method 1200 can be performed in a different order compared with the order shown in FIG. 12. Some operations of the method 1200 can be performed concurrently with other operations. In at least one embodiment, one or more operations shown in FIG. 12 may not always be performed.

At block 1202, processing units executing method 1200 can receive measurement data comprising at least one of transmitter settings and impairment properties associated with a transmitter circuit, channel properties and impairment properties associated with a channel between the transmitter circuit and a receiver circuit, link properties and impairment properties associated with a link between the transmitter circuit and the receiver circuit, or receiver settings and impairment properties associated with the receiver circuit. At block 1204, processing units executing method 1200 can determine, using the measurement data and a DNN, a post-FEC BER estimation of a FEC circuit. At block 1206, processing units executing method 1200 can adjust, based on the post-FEC BER estimation, at least one of a FEC parameter of the FEC circuit or a link parameter of the receiver circuit.

In at least one embodiment, the processing units executing method 1200 can train the DNN based on training data and at least one of a codeword histogram, a burst histogram, or a SNR histogram. The training data can include one or more of the following: additional transmitter settings and impairment properties associated with the transmitter circuit, additional channel properties and impairment properties associated with the channel between the transmitter circuit and the receiver circuit, additional link properties and impairment properties associated with the link between the transmitter circuit and the receiver circuit, additional receiver settings and impairment properties associated with the receiver circuit, or environmental properties. In some embodiments, the training data includes pre-FEC performance training data.

In at least one embodiment, the processing units executing method 1200 can train the DNN by: determining, using the DNN with current model parameters, a first training post-FEC BER estimation; determining, using a semi-analytic model and the at least one of the codeword histogram, the burst histogram, or the SNR histogram, a second training post-FEC BER estimation; determining an error signal between the first training post-FEC BER estimation and the second training post-FEC BER estimation; updating, using the error signal, the current model parameters to obtain trained model parameters for the DNN; and outputting trained model parameters of the DNN.

In at least one embodiment, the processing units executing method 1200 can train the DNN by: determining, using the DNN with current model parameters, a first training post-FEC BER estimation; determining, using a semi-analytic model and the at least one of the codeword histogram, the burst histogram, or the SNR histogram, a second training post-FEC BER estimation; determining, using a random error model and pre-FEC performance training data, a third training post-FEC BER estimation; determining a difference estimation between the second training post-FEC BER estimation and the third training post-FEC BER estimation; determining an error signal between the first training post-FEC BER estimation and the third training post-FEC BER estimation; updating, using the error signal, the current model parameters to obtain trained model parameters for the DNN; outputting trained model parameters of the DNN; determining, using the DNN with the trained model parameters, second difference estimation; determining, using pre-FEC performance data and the random error model, a second post-FEC BER estimation; and determining, using the second difference estimation and the second post-FEC BER estimation, the post-FEC BER estimation.

In a further embodiment, the processing units executing method 1200 can adjust at least one of the FEC parameter or the link parameter by changing an interleave factor of an interleaver of the FEC system from a first value to a second value.

In a further embodiment, the processing units executing method 1200 can adjust at least one of the FEC parameter or the link parameter by changing a first interleave factor of a first interleaver of the FEC system from a first value to a second value, and changing a second interleave factor of a second interleaver of the FEC system from a third value to a fourth value.

In a further embodiment, the receiver circuit is a SerDes circuit, and the processing units executing method 1200 can adjust at least one of the FEC parameter or the link parameter by changing a SerDes parameter of the SerDes circuit from a first value to a second value.

In a further embodiment, the receiver circuit is a SerDes circuit, and the processing units executing method 1200 can adjust at least one of the FEC parameter or the link parameter by changing an interleave factor of an interleaver of the FEC system from a first value to a second value, and changing a SerDes parameter of the SerDes circuit from a third value to a fourth value.

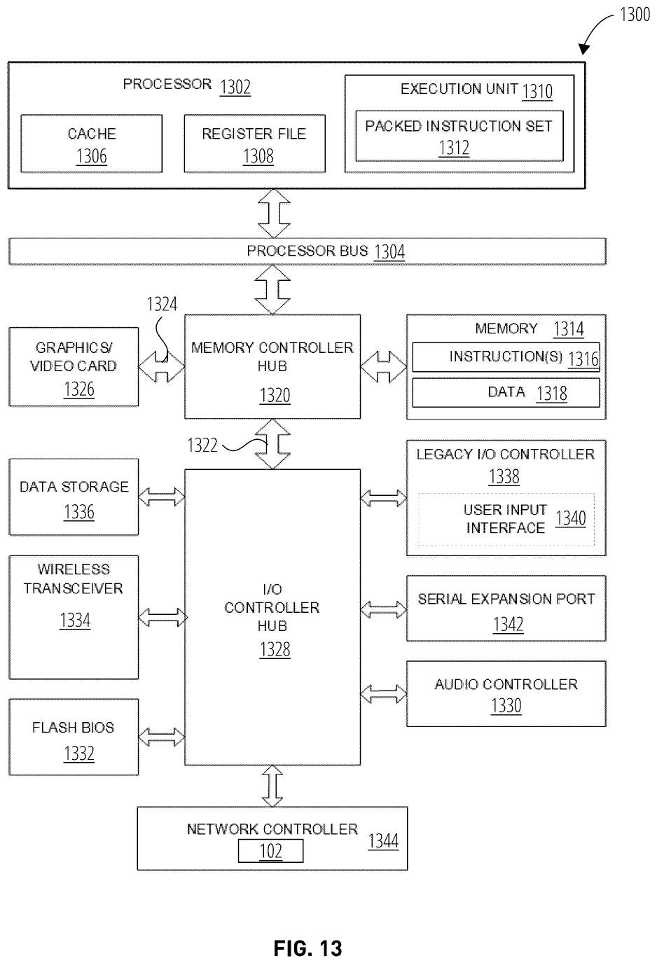

FIG. 13 illustrates an example computer system 1300, including a network controller 1344 with a DNN-based estimation system 102 for optimizing post-FEC BER performance of an FEC system, in accordance with at least some embodiments. In at least one embodiment, computer system 1300 may be a system with interconnected devices and components, a System on Chip (SoC), or some combination. In at least one embodiment, computer system 1300 is formed with a processor 1302 that may include execution units to execute an instruction. In at least one embodiment, computer system 1300 may include, without limitation, a component, such as a processor 1302, to employ execution units including logic to perform algorithms for processing data. In at least one embodiment, computer system 1300 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1300 may execute a version of WINDOWS' operating system available from Microsoft Corporation of Redmond, Wash., although other operating systems (UNIX and Linux, for example), embedded software, and/or graphical user interfaces, may also be used.

In at least one embodiment, computer system 1300 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 1300 may be used in devices such as graphics processing units (GPUs), network adapters, central processing units, and network devices such as switches (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 1300 may include, without limitation, processor 1302 that may include, without limitation, one or more execution units 807 that may be configured to execute a Compute Unified Device Architecture (“CUDA”) (CUDA® is developed by NVIDIA Corporation of Santa Clara, California) program. In at least one embodiment, a CUDA program is at least a portion of a software application written in a CUDA programming language. In at least one embodiment, computer system 1300 is a single processor desktop or server system. In at least one embodiment, computer system 1300 may be a multiprocessor system. In at least one embodiment, processor 1302 may include, without limitation, a complex instruction set computer (CISC) microprocessor, a reduced instruction set computer (RISC) microprocessor, a Very Long Instruction Word (VLIW) microprocessor, and a processor implementing a combination of instruction sets, or any other processor device, such as a digital signal processor, for example. In at least one embodiment, processor 1302 may be coupled to a processor bus 1304 that may transmit data signals between processor 1302 and other components in computer system 1300.

In at least one embodiment, processor 1302 may include, without limitation, a Level 1 (“L1”) internal cache memory (“cache”) 1306. In at least one embodiment, processor 1302 may have a single internal cache or multiple levels of internal cache. In at least one embodiment, cache memory may reside externally to processor 1302. In at least one embodiment, processor 1302 may also include a combination of both internal and external caches. In at least one embodiment, a register file 1308 may store different types of data in various registers including, without limitation, integer registers, floating point registers, status registers, and instruction pointer register.

In at least one embodiment, execution unit 1310, including, without limitation, logic to perform integer and floating point operations, also resides in processor 1302. Processor 1302 may also include a microcode (“ucode”) read only memory (“ROM”) that stores microcode for certain macro instructions. In at least one embodiment, execution unit 1310 may include logic to handle a packed instruction set 1312. In at least one embodiment, by including packed instruction set 1312 in an instruction set of a general-purpose processor 1302, along with associated circuitry to execute instructions, operations used by many multimedia applications may be performed using packed data in a general-purpose processor 1302. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 1310 may also be used in microcontrollers, embedded processors, graphics devices, DSPs, and other types of logic circuits. In at least one embodiment, computer system 1300 may include, without limitation, a memory 1314. In at least one embodiment, memory 1314 may be implemented as a Dynamic Random Access Memory (DRAM) device, a Static Random Access Memory (SRAM) device, flash memory device, or other memory devices. Memory 1314 may store instruction(s) 1316 and/or data 1318 represented by data signals that may be executed by processor 1302.

In at least one embodiment, a system logic chip may be coupled to a processor bus 1304 and memory 1314. In at least one embodiment, the system logic chip may include, without limitation, a memory controller hub (“MCH”) 1320, and processor 1302 may communicate with MCH 1320 via processor bus 1304. In at least one embodiment, MCH 1320 may provide a high bandwidth memory path to memory 1314 for instruction and data storage and for storage of graphics commands, data, and textures. In at least one embodiment, MCH 1320 may direct data signals between processor 1302, memory 1314, and other components in computer system 1300 and may bridge data signals between processor bus 1304, memory 1314, and a system I/O 1322. In at least one embodiment, a system logic chip may provide a graphics port for coupling to a graphics controller. In at least one embodiment, MCH 1320 may be coupled to memory 1314 through high bandwidth memory path, and graphics/video card 1326 may be coupled to MCH 1320 through an Accelerated Graphics Port (“AGP”) interconnect 1324.

In at least one embodiment, computer system 1300 may use system I/O 1322 that is a proprietary hub interface bus to couple MCH 1320 to I/O controller hub (“ICH”) 1328. In at least one embodiment, ICH 1328 may provide direct connections to some I/O devices via a local I/O bus. In at least one embodiment, a local I/O bus may include, without limitation, a high-speed I/O bus for connecting peripherals to memory 1314, a chipset, and processor 1302. Examples may include, without limitation, an audio controller 1330, a firmware hub (“flash BIOS”) 1332, a wireless transceiver 1334, a data storage 1336, a legacy I/O controller 1338 containing a user input interface 1340, a keyboard interface, a serial expansion port 1342, such as a USB port, and a network controller 644, including the DNN-based estimation system 102 as described herein. Data storage 1336 may comprise a hard disk drive, a floppy disk drive, a CD-ROM device, a flash memory device, or other mass storage device.

In at least one embodiment, FIG. 13 illustrates a computer system 1300, which includes interconnected hardware devices or “chips.” In at least one embodiment, FIG. 13 may illustrate an example SoC. In at least one embodiment, devices illustrated in FIG. 13 may be interconnected with proprietary interconnects, standardized interconnects (e.g., Peripheral Component Interconnect Express (PCIe), or some combination thereof. In at least one embodiment, one or more components of computer system 1300 are interconnected using compute express link (“CXL”) interconnects.

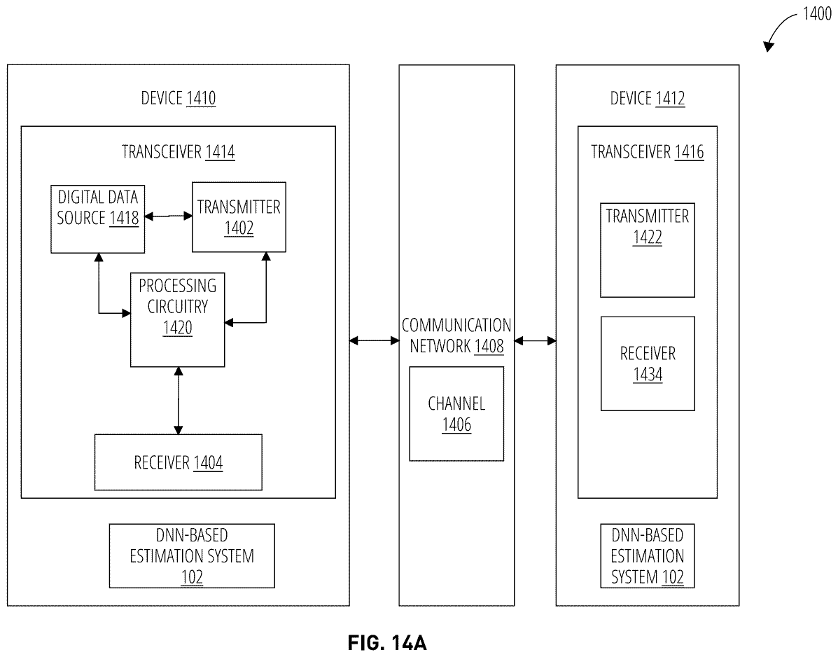

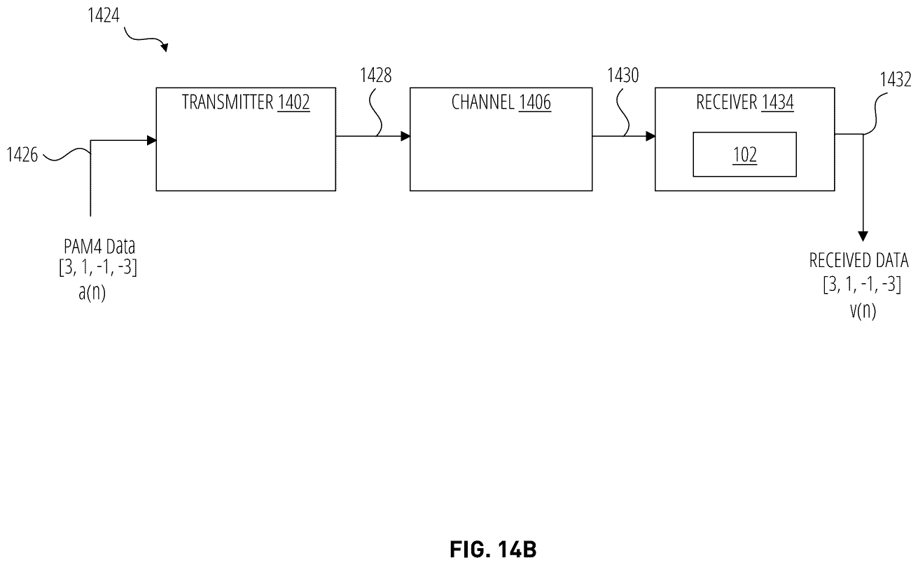

FIG. 14A illustrates an example communication system 1400 with a DNN-based estimation system 102 for optimizing post-FEC BER performance of an FEC system, in accordance with at least some embodiments. The communication system 1400 includes a device 1410, a communication network 1408 including a communication channel 1406, and a device 1412. In at least one embodiment, the devices 1410 and 1412 are integrated circuits of a Personal Computer (PC), a laptop, a tablet, a smartphone, a server, a collection of servers, or the like. In some embodiments, the devices 1410 and 1412 may correspond to any appropriate type of device that communicates with other devices also connected to a common type of communication network 1408. According to embodiments, the transmitter 1402 and 1422 of devices 1410 or 1412 may correspond to transmitters of a Graphics Processing Unit (GPU), a switch (e.g., a high-speed network switch), a network adapter, a central processing unit (CPU), a data processing unit (DPU), etc.

Examples of the communication network 1408 that may be used to connect the devices 1410 and 1412 include wires, conductive traces, bumps, terminals, optical fibers, or the like. In other embodiments, the communication network 1408 can be a Peripheral Component Interconnect Express (PCIe) interconnect. PCIe is a high-speed interface standard used to connect various hardware components. It can be an interconnect for devices such as graphics cards (GPUs), solid-state drives (SSDs), network cards, and other peripherals. PCIe offers a scalable, high-speed, and point-to-point connection between devices, including CPUs, GPUs, memory, and the like. In other embodiments, the communication network 1408 can be a high-speed interconnect, such as an interconnect that deploys the NVLink technology. The NVLink interconnect can be a GPU-GPU interconnect used between GPUs, a CPU-GPU interconnect between GPUs and CPUs, or an interconnect used between other devices. NVLink offers a higher bandwidth and lower latency than traditional PCIe connections, which are typically used in computing hardware. NVLink is especially useful in scenarios that require massive parallel processing, such as artificial intelligence (AI), machine learning, deep learning, high-performance computing (HPC), and data analytics. For example, in NVIDIA's DGX systems and high-end gaming or AI workstations, NVLink helps GPUs exchange data at speeds that are necessary for demanding tasks like real-time ray tracing or training neural networks. In one specific, but non-limiting example, the communication network 1408 is a network that enables data transmission between the devices 1410 and 1412 using data signals (e.g., digital, optical, wireless signals), clock signals, or both. The embodiments described herein can be utilized in a system with a high-speed, scalable switch, such as a switch using the NVSwitch technology. NVSwitch is a high-speed, scalable switch developed by NVIDIA that facilitates data communication between multiple GPUs in a system, allowing them to work together more efficiently by providing high-bandwidth, low-latency interconnections. The NVSwitch serves as a central hub or high-bandwidth fabric that interconnects all the GPUs in a system, enabling each GPU to communicate with every other GPU quickly and efficiently. The NVSwitch can be coupled between other types of devices, such as CPUs, accelerators, memory, or the like. The NVSwitch can be used for tasks requiring intense computation and collaboration between multiple GPUs, such as AI model training, scientific simulations, and large-scale data processing. The embodiments described herein can be used in a high-performance computing system, such as a computing system modeled after NVIDIA's DGX systems, which are designed specifically for artificial intelligence (AI), deep learning, and high-performance computing (HPC) workloads. DGX systems are optimized for large-scale GPU computation and parallel processing, integrating multiple GPUs, high-bandwidth interconnects, and software frameworks tailored for AI and HPC tasks. In at least one embodiment, a system for high-speed network communication includes a processing unit, a network interface comprising a receiver or transceiver with the controller In at least one embodiment, a system for high-speed network communication includes a processing unit, a network interface comprising a receiver or transceiver with a DNN-based estimation system 102 to optimize post-FEC BER performance of an FEC system using a post-FEC correlated performance metric, as described herein. The processing unit can include a CPU, a GPU, a DPU, a network adapter, a network switch, an NVLink switch, or the like. 2436, as described herein.

Other examples for the communication network 1408 can include other chip-to-chip or die-to-die interconnects, such as GRS, LPI (low power interface) or LLI (low latency interface).

The device 1410 includes a transceiver 1414 for sending and receiving signals, for example, data signals. The data signals may be digital or optical signals modulated with data or other suitable signals for carrying data.

The transceiver 1414 may include a digital data source 1418, a transmitter 2402, a receiver 1404, and processing circuitry 1420 that controls the transceiver 1414. The digital data source 1418 may include suitable hardware and/or software for outputting data in a digital format (e.g., in binary code and/or thermometer code). The digital data output by the digital data source 1418 may be retrieved from memory (not illustrated) or generated according to input (e.g., user input). The transceiver 1414 can include the DNN-based estimation system 102 as described above with respect to FIG. 1 and FIG. 2.

The transceiver 1414 includes suitable software and/or hardware for receiving digital data from the digital data source 1418 and outputting data signals according to the digital data for transmission over the communication network 1408 to a transceiver 1416 of device 1412.

The receiver 1404 of device 1410 may include suitable hardware and/or software for receiving signals, for example, data signals from the communication network 1408. For example, the receiver 1404 may include components for receiving processing signals to extract the data for storing in a memory. In at least one embodiment, the transceiver 1416 includes a transmitter 1422 and receive 1434. The transceiver 1416 receives an incoming signal and samples the incoming signal to generate samples, such as using an analog-to-digital converter (ADC). The ADC can be controlled by a clock-recovery circuit (or clock recovery block) in a closed-loop tracking scheme. The clock-recovery circuit can include a controlled oscillator, such as a voltage-controlled oscillator (VCO) or a digitally-controlled oscillator (DCO) that controls the sampling of the subsequent data by the ADC. The transceiver 1416 can include the DNN-based estimation system 102 as described above with respect to FIG. 1 and FIG. 2.

The processing circuitry 1420 may comprise software, hardware, or a combination thereof. For example, the processing circuitry 1420 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry 1420 may comprise hardware, such as an Application-Specific Integrated circuit (ASIC). Other non-limiting examples of the processing circuitry 1420 include an Integrated Circuit (IC) chip, a CPU, A GPU, a DPU, a microprocessor, a Field-Programmable Gate Array (FPGA), a collection of logic gates or transistors, resistors, capacitors, inductors, diodes, or the like. Some or all of the processing circuitry 1420 may be provided on a Printed Circuit Board (PCB) or collection of PCBs. It should be appreciated that any appropriate type of electrical component or collection of electrical components may be suitable for inclusion in the processing circuitry 1420. The processing circuitry 1420 may send and/or receive signals to and/or from other elements of the transceiver 1414 to control the overall operation of the transceiver 1414.

The transceiver 1414 or selected elements of the transceiver 1414 may take the form of a pluggable card or controller for the device 1410. For example, the transceiver 1414 or selected elements of the transceiver 1414 may be implemented on a network interface card (NIC).

The device 1412 may include a transceiver 1416 for sending and receiving signals, for example, data signals over a channel 1406 of the communication network 1408. The channel 2406 can be PCIe, NVLink, Ethernet, InfiniBand, Ground Reference Signal (GRS), Chip-to-Chip (C2C), Die-to-Die (D2D), or the like. The same or similar structure of the transceiver 1414 may be applied to transceiver 1416, and thus, the structure of transceiver 1416 is not described separately.

Although not explicitly shown, it should be appreciated that devices 1410 and 1412 and the transceiver 1414 and transceiver 1416 may include other processing devices, storage devices, and/or communication interfaces generally associated with computing tasks, such as sending and receiving data.

FIG. 14B illustrates a block diagram of an example communication system 1424 employing a receiver 1434 with a DNN-based estimation system 102 for optimizing post-FEC BER performance of an FEC system, according to at least one embodiment. In the example shown in FIG. 14B, a Pulse Amplitude Modulation level-4 (PAM4) modulation scheme is employed with respect to the transmission of a signal (e.g., digitally encoded data) from a transmitter (TX) 1402 to a receiver (RX) 1434 via a communication channel 1406 (e.g., a transmission medium). The communication channel 2406 can be PCIe, NVLink, Ethernet, InfiniBand, GRS, C2C, D2D, or the like. In this example, the transmitter 1402 receives an input data 1426 (i.e., the input data at time n is represented as “a(n)”), which is modulated in accordance with a modulation scheme (e.g., PAM4) and sends the signal 1428 a(n) including a set of data symbols (e.g., symbols −3, −1, 1, 3, where the symbols represent coded binary data). It is noted that while the use of the PAM4 modulation scheme is described herein by way of example, other data modulation schemes can be used in accordance with embodiments of the present disclosure, including for example, a non-return-to-zero (NRZ) modulation scheme, PAM3, PAM7, PAM8, PAM16, etc. For example, for an NRZ-based system, the transmitted data symbols consist of symbols −1 and 1, with each symbol value representing a binary bit. This is also known as a PAM level-2 or PAM2 system as there are 2 unique values of transmitted symbols. Typically, a binary bit 0 is encoded as −1, and a bit 1 is encoded as 1 as the PAM2 values.

In the example shown, the PAM4 modulation scheme uses four (4) unique values of transmitted symbols to achieve higher efficiency and performance. The four levels are denoted by symbol values −3, −1, 1, 3, with each symbol representing a corresponding unique combination of binary bits (e.g., 00, 01, 10, 11).

The communication channel 1406 is a destructive medium in that the channel acts as a low pass filter which attenuates higher frequencies more than it attenuates lower frequencies, introduces inter-symbol interference (ISI) and noise from cross talk, from power supplies, from Electromagnetic Interference (EMI), or from other sources. The communication channel 1406 can be over serial links (e.g., a cable, PCB traces, copper cables, optical fibers, or the like), read channels for data storage (e.g., hard disk, flash solid-state drives (SSDs), high-speed serial links, deep space satellite communication channels, applications, or the like. The receiver (RX) 1434 receives an incoming signal 1430 over the channel 1406. The receiver 1434 can output a received signal 1432, “v(n),” including the set of data symbols (e.g., symbols −3, −1, 1, 3, wherein the symbols represent coded binary data).

In at least one embodiment, the transmitter 1402 can be part of a SerDes IC. The SerDes IC can be a transceiver that converts parallel data to serial data and vice versa. The SerDes IC can facilitate transmission between two devices over serial streams, reducing the number of data paths, wires/traces, terminals, etc. The receiver 1434 can be part of a SerDes IC. The SerDes IC can include a clock-recovery circuit. The clock-recovery circuit can be coupled to an ADC and an equalization block. In another embodiment, the SerDes IC can include additional equalization block before a symbol detector.

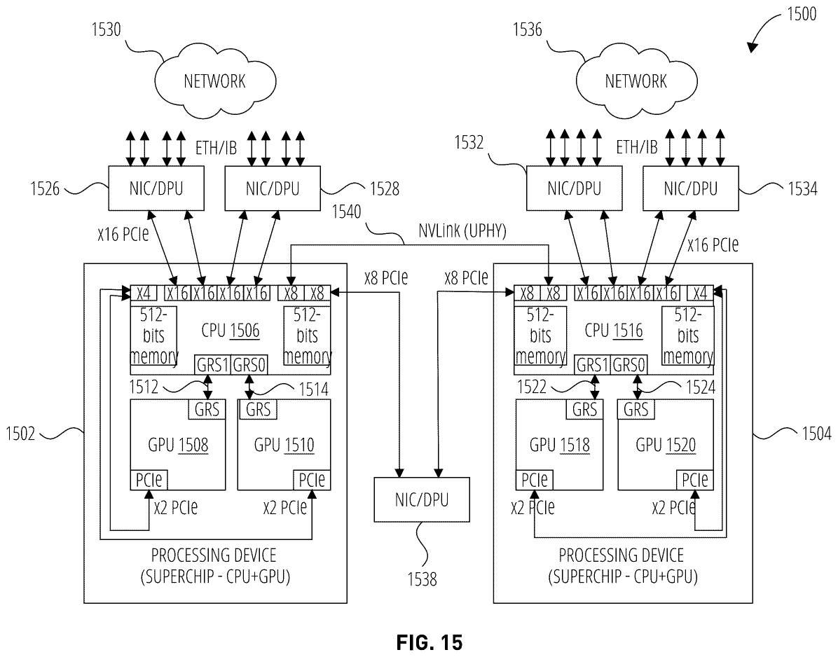

FIG. 15 is a block diagram of a computing system 1500 having two processing devices coupled to each other and multiple networks according to at least one embodiment. The computing system 1500 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 1500. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 1500 highly suitable for demanding applications that require significant processing power, such as artificial intelligence (AI), machine learning (ML), and data-intensive computing, while ensuring robust connectivity and scalability across various networked environments. The integrated circuits of the computing system 1500 can include one or more CPUs and one or more GPUs. An example architecture of a multi-GPU architecture is illustrated in FIG. 15.

As illustrated in FIG. 15, the computing system 1500 includes a processing device 1502 with a multi-GPU architecture. In particular, the processing device 1502 includes a CPU 1506, a GPU 1508, and a GPU 1510. The CPU 1506 can be coupled to the GPU 1508 via a die-to-die (D2D) or chip-to-chip (C2C) interconnect 1512, such as a Ground-Referenced Signaling interconnect (GRS interconnect). The CPU 1506 can be coupled to the GPU 1510 via a D2D or C2C interconnect 1514. The CPU 1506 can also be coupled to the GPU 1508 and GPU 1510 via PCIe interconnects. The CPU 1506 can be coupled to one or more network interface cards (NICs) or data processing units (DPUs), which are coupled to one or more networks. For example, as illustrated in FIG. 15, the CPU 1506 is coupled to a first NIC/DPU 1526, which is coupled to a network 1530. The CPU 1506 is also coupled to a second NIC/DPU 1528, which is coupled to the network 1530. The NIC/DPU 1526 and NIC/DPU 1528 can be coupled to the network 1530 over Ethernet (ETH) or InfiniBand (IB) connections.

The computing system 1500 also includes a processing device 1504 with a multi-GPU architecture. In particular, the processing device 1504 includes a CPU 1516, a GPU 1518, and a GPU 1520. The CPU 1516 can be coupled to the GPU 1518 via an D2D or C2C interconnect 1522. The CPU 1516 can be coupled to the GPU 1520 via a D2D or C2C interconnect 1524. The CPU 1516 can also be coupled to the GPU 1518 and GPU 1520 via PCIe interconnects. The CPU 1516 can be coupled to one or more NICs or DPUs, which are coupled to one or more networks. For example, as illustrated in FIG. 15, the CPU 1516 is coupled to a first NIC/DPU 1532, which is coupled to a network 1536. The CPU 1516 is also coupled to a second NIC/DPU 1534, which is coupled to the network 1536. The NIC/DPU 1532 and NIC/DPU 1534 can be coupled to the network 1536 over Ethernet (ETH) or InfiniBand (IB) connections.

In at least one embodiment, the processing device 1502 and the processing device 1504 can communicate with each other via a NIC/DPU 1538, such as over PCIe interconnects. The processing device 1502 and processing device 1504 can also communicate with each other over high-bandwidth communication interconnects 1540, such as an NVLink interconnect or other high-speed interconnects. The NIC/DPUs of FIG. 15 can be the various embodiments of the DPUs described herein. The DNN-based estimation system 102 can be implemented in any receiver device of any of the devices described herein.

In at least one embodiment, the computing system 1500 is used for high-speed network communication and includes a processing unit (e.g., CPU 1506, GPU 1508, GPU 1510, CPU 1516, GPU 1518, GPU 1520, NIC/DPU 1526, NIC/DPU 1528, NIC/DPU 1532, NIC/DPU 1534, or NIC/DPU 1538), and a network interface coupled to the processing unit. The network interface can include the operations and functionality of the DNN-based estimation system 102 described herein.

In at least one embodiment, the computing system 1500 includes a host device and an auxiliary device. The auxiliary device includes a device memory and a processor, communicably coupled to the device memory. The auxiliary device performs the operations described herein with respect to FIG. 1 to FIG. 12. The auxiliary device can include a GPU. The auxiliary device can include a DPU. The auxiliary device can include a DPU. The auxiliary device can include accelerator hardware.

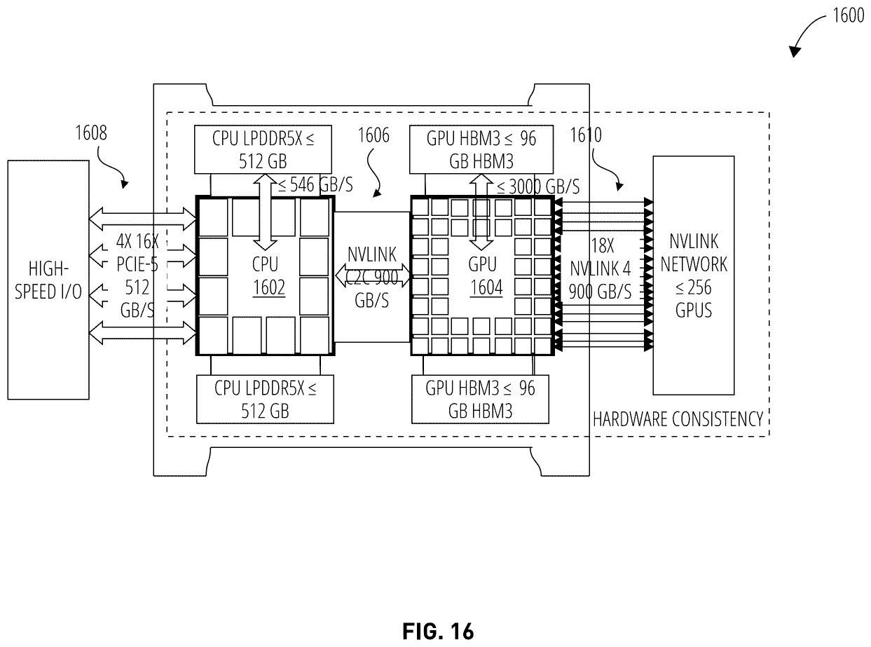

FIG. 16 is a block diagram of a computing system 1600 having a CPU 1602 and a GPU 1604 in a single integrated circuit according to at least one embodiment. The computing system 1600 can be a highly integrated design where a CPU 1602 and GPU 1604 are connected on a single integrated circuit, utilizing an NVLink C2C (Chip-to-Chip) interconnect 1606 to enable fast, low-latency communication between the two processing units. This close integration allows for efficient data transfer and parallel processing between the CPU 1602 and GPU 1604, optimizing performance for complex computational tasks. The GPU elements within the computing system 1600 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 1610. Additionally, the computing system 1600 can be designed to interface with a high-speed I/O through PCIe interconnects 1608, ensuring rapid data transfer to and from external devices, further enhancing the system's capabilities in handling data-intensive tasks and providing robust connectivity to peripheral components. It should be noted that the C2C interconnects 1606 can be considered D2D interconnects since the CPU 1602 and the GPU 1604 are located on the same integrated circuit. The integrated circuit can include CPU memory (also referred to as main memory) and GPU memory, which are accessible by the CPU 1602 and the GPU 1604, respectively, over high-speed interconnects. The computing system 1600 can bring together performance of the GPU 1604 with the versatility of the CPU 1602. The CPU 1602 can be connected with high-bandwidth and memory coherent C2C interconnects 1606 in a single integrated circuit. The computing system 1600 can support a link switch system.

The computing system 1600 can include the DNN-based estimation system 102 used for the various embodiments described herein with respect to FIG. 1 to FIG. 12. The DNN-based estimation system 102 can be implemented in any receiver device of any of the devices described herein.

In at least one embodiment, the computing system 1600 is used for high-speed network communication and includes a processing unit, and a network interface coupled to the processing unit. The network interface can include the operations and functionality of the DNN-based estimation system 102 described herein.

In at least one embodiment, the computing system 1600 includes a host device and an auxiliary device. The auxiliary device includes a device memory and a processor, communicably coupled to the device memory. The auxiliary device performs the operations described herein with respect to FIG. 1 to FIG. 12. The auxiliary device can include a GPU. The auxiliary device can include a DPU. The auxiliary device can include a DPU. The auxiliary device can include accelerator hardware.

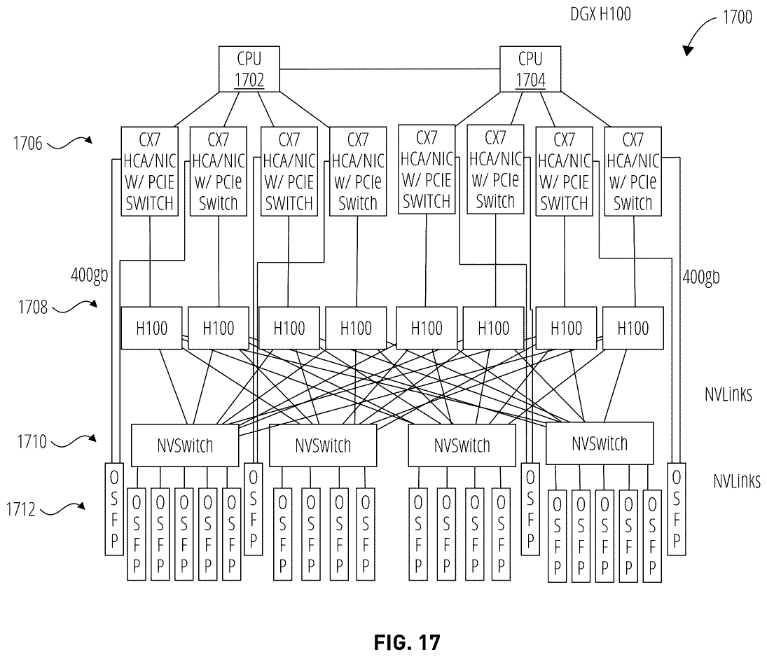

FIG. 17 is a block diagram of a computing system 1700 having tensor core GPUs 1708 according to at least one embodiment. The computing system 1700 can be a DGX H100 system, which is a high-performance computing platform designed to meet the demands of AI, ML, and deep learning (DL) workloads. The computing system 1700 can include multiple tensor core GPUs 1708 (e.g., NVIDIA H100 Tensor Core GPUs). The tensor core GPUs 1708 can each be one of the integrated circuits described above with respect to FIG. 12. The tensor core GPUs 1708 can be optimized for AI/ML/DL applications, offering exceptional performance for deep learning training, inference, and high-performance computing tasks. The tensor core GPUs 1708 within the computing system 1700 are interconnected using high-speed communication interfaces like NVLinks, enabling rapid data transfer between them, which is crucial for handling large-scale AI models and datasets with low latency. This computing system 1700 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1708, the computing system 1700 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1708 for their specific applications. The computing system 1700 is ideally suited for large-scale AI model training, real-time inference, scientific simulations, data analytics, and other compute-intensive tasks that require massive parallel processing power.

The tensor core GPUs 1708 can be coupled to multiple CPUs, such as CPU 1702 and CPU 1704, using switches 1706 (e.g., CX7 HCA/NIC with PCIe switch). The tensor core GPUs 1708 can be coupled to each other via switches 1710 (e.g., NVSwitches). The switches 1706 and switches 1710 can be coupled to high-speed transceiver modules 1712. The high-speed transceiver modules 1712 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1700 remains capable of meeting increasing data demands and can be upgraded to support future advancements in network speeds, thus contributing to the system's overall performance and scalability.

In at least one embodiment, the computing system 1700 can be considered a data-network configuration with full-bandwidth intra-server NVLinks. In this example, all eight tensor core GPUs 1708 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1708 can half-subscribe eighteen NVLinks to GPUs in other servers. Four tensor core GPUs 1708 can saturate eighteen NVLinks to GPUs in other servers. This is equivalent of full bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 1708 can independently transfer data, using Remote Direct Memory Access (RDMA) protocol, over its own dedicated switch (e.g., 400 Gb/s HCA/NIC) in a multi-rail InfiniBand/Ethernet configuration. In this example, 800 GBps of aggregate full duplex to non-NVLink network devices.

The NICs/switches of computing system 1700 can include the various embodiments described herein with respect to FIG. 1 to FIG. 9.

In at least one embodiment, the computing system 1700 is used for high-speed network communication and includes a processing unit (e.g., CPU 1702, CPU 1704, switches 1706, tensor core GPUs 1708, switches 1710, high-speed transceiver modules 1712), and a network interface coupled to the processing unit. The network interface can include a receiver or a transceiver and perform the corresponding operations and functionalities described herein. The processing unit can include a CPU, a GPU, a DPU, a network adapter, a network switch, an NVLink switch, or the like.

In at least one embodiment, the computing system 1700 includes a host device and an auxiliary device. The auxiliary device includes a device memory and a processor, communicably coupled to the device memory. The auxiliary device performs the operations described herein with respect to FIG. 1 to FIG. 9. The auxiliary device can include a GPU. The auxiliary device can include a DPU. The auxiliary device can include a DPU. The auxiliary device can include accelerator hardware.

### Inference and Training Logic

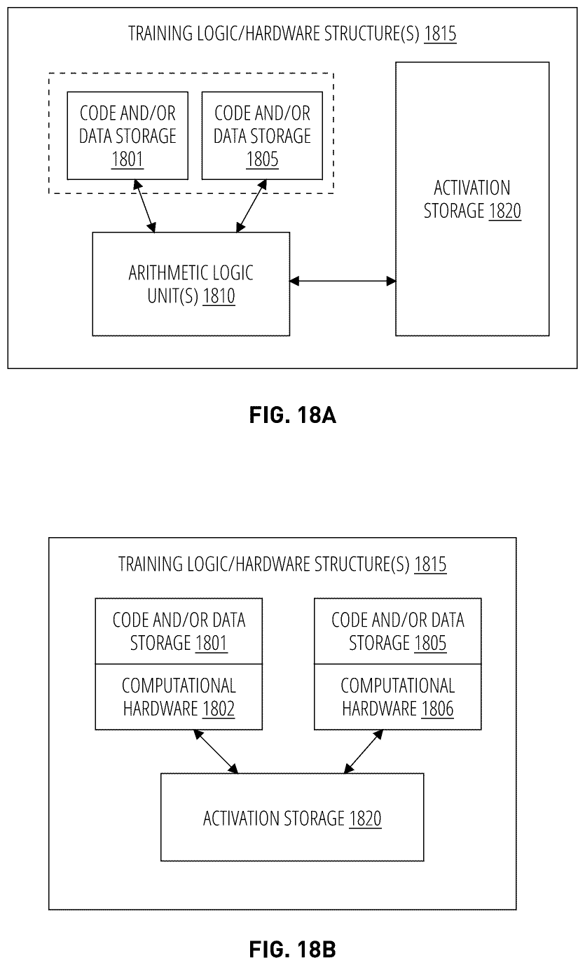

FIG. 18A illustrates inference and/or training logic 1815 used to perform inferencing and/or training operations associated with one or more embodiments.

In at least one embodiment, inference and/or training logic 1815 may include code and/or data storage 1801 to store forward and/or output weights and/or input/output data, and other parameters to configure neurons or layers of a neural network trained and/or used for inferencing. In at least one embodiment, training logic 1815 may include (or be coupled to code and/or data storage 1801 that stores) graph code or other software to control the timing and/or order in which weight and/or other parameter information is to be loaded to configure processing units, including logic units, integer and/or floating point units (collectively, arithmetic logic units (ALUs), or simply circuits). In at least one embodiment, code, such as graph code, loads weight or other parameter information into processor ALUs based on the architecture of a neural network to which such code corresponds. In at least one embodiment, code and/or data storage 1801 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 1801 may be included with other on-chip or off-chip data storage, including a processor's L1, L2, or L3 cache or system memory.

In at least one embodiment, any portion of code and/or data storage 1801 may be internal or external to one or more processors or other hardware logic devices or circuits. In at least one embodiment, code and/or data storage 1801 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 1801 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 1815 may include, without limitation, a code and/or data storage 1805 to store backward and/or output weight and/or input/output data corresponding to neurons or layers of a neural network trained and/or used for inferencing in aspects of one or more embodiments. In at least one embodiment, code and/or data storage 1805 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 1815 may include (or be coupled to code and/or data storage 1805 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on the architecture of a neural network to which such code corresponds. In at least one embodiment, any portion of code and/or data storage 1805 may be included with other on-chip or off-chip data storage, including a processor's L1, L2, or L3 cache or system memory. In at least one embodiment, any portion of code and/or data storage 1805 may be internal or external to one or more processors or other hardware logic devices or circuits. In at least one embodiment, code and/or data storage 1805 may be cache memory, DRAM, SRAM, non-volatile memory (e.g., flash memory), or other storage. In at least one embodiment, a choice of whether code and/or data storage 1805 is internal or external to a processor, for example, or comprises DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 1801 and code and/or data storage 1805 may be separate storage structures. In at least one embodiment, code and/or data storage 1801 and code and/or data storage 1805 may be a combined storage structure. In at least one embodiment, code and/or data storage 1801 and code and/or data storage 1805 may be partially combined and partially separate. In at least one embodiment, any portion of code and/or data storage 1801 and code and/or data storage 1805 may be included with other on-chip or off-chip data storage, including a processor's L1, L2, or L3 cache or system memory.

In at least one embodiment, inference and/or training logic 1815 may include one or more arithmetic logic unit(s) (“ALU(s)”) 1810, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 1820 that are functions of input/output and/or weight parameter data stored in code and/or data storage 1801 and/or code and/or data storage 1805. In at least one embodiment, activations stored in activation storage 1820 are generated according to linear algebraic and/or matrix-based mathematics performed by ALU(s) 1810 in response to performing instructions or other code, wherein weight values stored in code and/or data storage 1805 and/or code and/or data storage 1801 are used as operands along with other values, such as bias values, gradient information, momentum values, or other parameters or hyperparameters, any or all of which may be stored in code and/or data storage 1805 or code and/or data storage 1801 or another storage on or off-chip.

In at least one embodiment, ALU(s) 1810 are included within one or more processors or other hardware logic devices or circuits, whereas in another embodiment, ALU(s) 1810 may be external to a processor or other hardware logic device or circuit that uses them (e.g., a CO-processor). In at least one embodiment, ALU(s) 1810 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or data storage 1801, code and/or data storage 1805, and activation storage 1820 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 1820 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement, and/or other logical circuits.

In at least one embodiment, activation storage 1820 may be cache memory, DRAM, SRAM, non-volatile memory (e.g., flash memory), or other storage. In at least one embodiment, activation storage 1820 may be completely or partially within or external to one or more processors or other logical circuits. In at least one embodiment, a choice of whether activation storage 1820 is internal or external to a processor, for example, or comprises DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 1815 illustrated in FIG. 18A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 1815 illustrated in FIG. 18A may be used in conjunction with central processing unit (“CPU”) hardware, graphics processing unit (“GPU”) hardware or other hardware, such as field programmable gate arrays (“FPGAs”).

FIG. 18B illustrates inference and/or training logic 1815, according to at least one embodiment. In at least one embodiment, inference and/or training logic 1815 may include hardware logic in which computational resources are dedicated or otherwise exclusively used in conjunction with weight values or other information corresponding to one or more layers of neurons within a neural network. In at least one embodiment, inference and/or training logic 1815 illustrated in FIG. 18B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 1815 illustrated in FIG. 18B may be used in conjunction with central processing unit (CPU) hardware, graphics processing unit (GPU) hardware or other hardware, such as field programmable gate arrays (FPGAs). In at least one embodiment, inference and/or training logic 1815 includes code and/or data storage 1801 and code and/or data storage 1805, which may be used to store code (e.g., graph code), weight values and/or other information, including bias values, gradient information, momentum values, and/or other parameter or hyperparameter information. In at least one embodiment illustrated in FIG. 18B, each of code and/or data storage 1801 and code and/or data storage 1805 is associated with a dedicated computational resource, such as computational hardware 1802 and computational hardware 1806, respectively. In at least one embodiment, each of computational hardware 1802 and computational hardware 1806 comprises one or more ALUs that perform mathematical functions, such as linear algebraic functions, only on information stored in code and/or data storage 1801 and code and/or data storage 1805, respectively, the result of which is stored in activation storage 1820.

In at least one embodiment, each of code and/or data storage 1801 and 1805 and corresponding computational hardware 1802 and 1806, respectively, correspond to different layers of a neural network, such that resulting activation from one storage/computational pair 1801/1802 of code and/or data storage 1801 and computational hardware 1802 is provided as an input to a next storage/computational pair 1805/1806 of code and/or data storage 1805 and computational hardware 1806, to mirror a conceptual organization of a neural network. In at least one embodiment, each of storage/computational pairs 1801/1802 and 1805/1806 may correspond to more than one neural network layer. In at least one embodiment, additional storage/computation pairs (not shown) subsequent to or in parallel with storage/computation pairs 1801/1802 and 1805/1806 may be included in inference and/or training logic 1815.

### Neural Network Training and Deployment

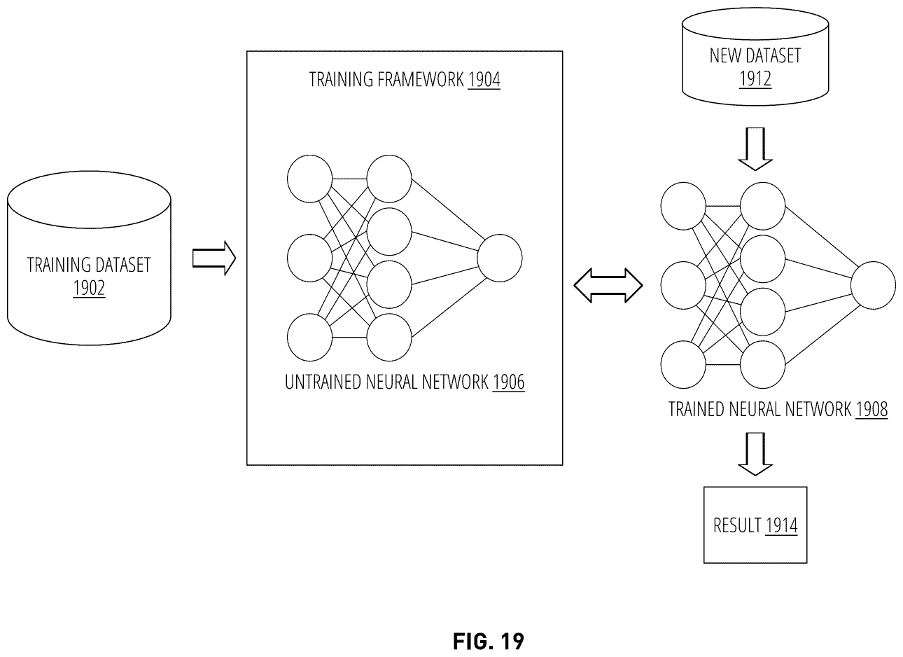

FIG. 19 illustrates training and deployment of a deep neural network, according to at least one embodiment. In at least one embodiment, untrained neural network 1906 is trained using a training dataset 1902. In at least one embodiment, training framework 1904 is a PyTorch framework, whereas in other embodiments, training framework 1904 is a TensorFlow, Boost, Caffe, Microsoft Cognitive Toolkit/CNTK, MXNet, Chainer, Keras, Deeplearning4j, or other training framework. In at least one embodiment, training framework 1904 trains an untrained neural network 1906 and enables it to be trained using processing resources described herein to generate a trained neural network 1908. In at least one embodiment, weights may be chosen randomly or by pre-training using a deep belief network. In at least one embodiment, training may be performed in either a supervised, partially supervised, or unsupervised manner.

In at least one embodiment, untrained neural network 1906 is trained using supervised learning, wherein training dataset 1902 includes an input paired with a desired output, or where training dataset 1902 includes input having a known output and an output of neural network 1906 is manually graded. In at least one embodiment, untrained neural network 1906 is trained in a supervised manner and processes inputs from training dataset 1902 and compares resulting outputs against a set of expected or desired outputs. In at least one embodiment, errors are then propagated back through untrained neural network 1906. In at least one embodiment, training framework 1904 adjusts weights that control untrained neural network 1906. In at least one embodiment, training framework 1904 includes tools to monitor how well untrained neural network 1906 is converging towards a model, such as trained neural network 1908, suitable for generating correct answers, such as in result 1914, based on input data such as a new dataset 1912. In at least one embodiment, training framework 1904 trains untrained neural network 1906 repeatedly while adjusting weights to refine an output of untrained neural network 1906 using a loss function and adjustment algorithm, such as stochastic gradient descent. In at least one embodiment, training framework 1904 trains untrained neural network 1906 until untrained neural network 1906 achieves a desired accuracy. In at least one embodiment, trained neural network 1908 can then be deployed to implement any number of machine learning operations.

In at least one embodiment, untrained neural network 1906 is trained using unsupervised learning, wherein untrained neural network 1906 attempts to train itself using unlabeled data. In at least one embodiment, unsupervised learning training dataset 1902 will include input data without any associated output data or “ground truth” data. In at least one embodiment, untrained neural network 1906 can learn groupings within training dataset 1902 and can determine how individual inputs are related to untrained dataset 1902. In at least one embodiment, unsupervised training can be used to generate a self-organizing map in trained neural network 1908 capable of performing operations useful in reducing dimensionality of new dataset 1912. In at least one embodiment, unsupervised training can also be used to perform anomaly detection, which allows identification of data points in new dataset 1912 that deviate from normal patterns of new dataset 1912.

In at least one embodiment, semi-supervised learning may be used, which is a technique in which training dataset 1902 includes a mix of labeled and unlabeled data. In at least one embodiment, training framework 1904 may be used to perform incremental learning, such as through transferred learning techniques. In at least one embodiment, incremental learning enables trained neural network 1908 to adapt to new dataset 1912 without forgetting knowledge instilled within trained neural network 1908 during initial training.

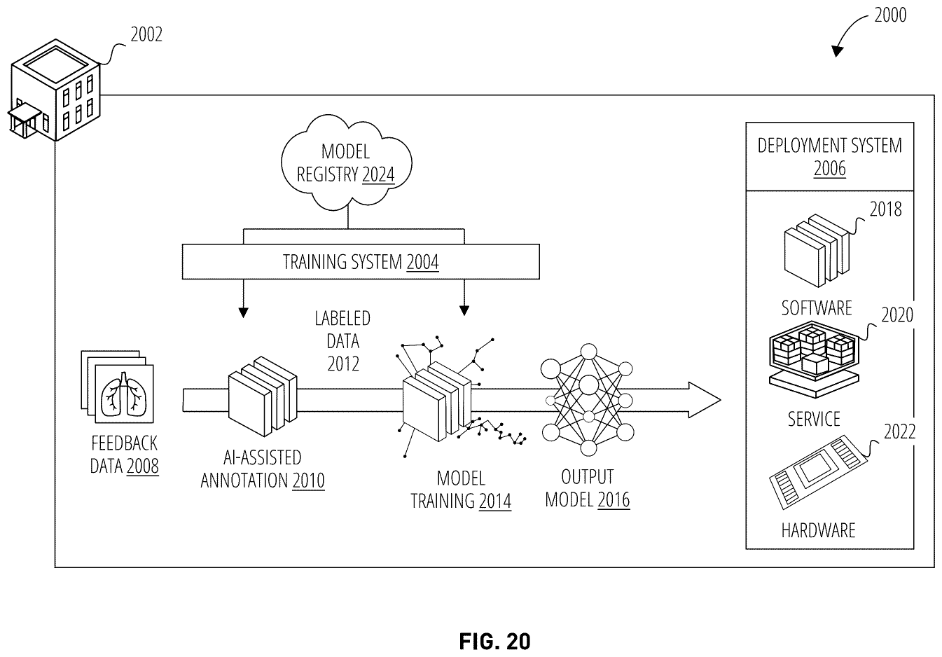

With reference to FIG. 20, FIG. 20 is an example data flow diagram for a process 2000 of generating and deploying a processing and inferencing pipeline, according to at least one embodiment. In at least one embodiment, process 2000 may be deployed to perform game name recognition analysis and inferencing on user feedback data at one or more facilities 2002, such as a data center.

In at least one embodiment, process 2000 may be executed within a training system 2004 and/or a deployment system 2006. In at least one embodiment, training system 2004 may be used to perform training, deployment, and embodiment of machine learning models (e.g., neural networks, object detection algorithms, computer vision algorithms, etc.) for use in deployment system 2006. In at least one embodiment, deployment system 2006 may be configured to offload processing and compute resources among a distributed computing environment to reduce infrastructure requirements at facility 2002. In at least one embodiment, deployment system 2006 may provide a streamlined platform for selecting, customizing, and implementing virtual instruments for use with computing devices at facility 2002. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 2006 during execution of applications.

In at least one embodiment, some applications used in advanced processing and inferencing pipelines may use machine learning models or other AI to perform one or more processing steps. In at least one embodiment, machine learning models may be trained at facility 2002 using feedback data 2008 (such as imaging data) stored at facility 2002 or feedback data 2008 from another facility or facilities, or a combination thereof. In at least one embodiment, training system 2004 may be used to provide applications, services, and/or other resources for generating working, deployable machine learning models for deployment system 2006.

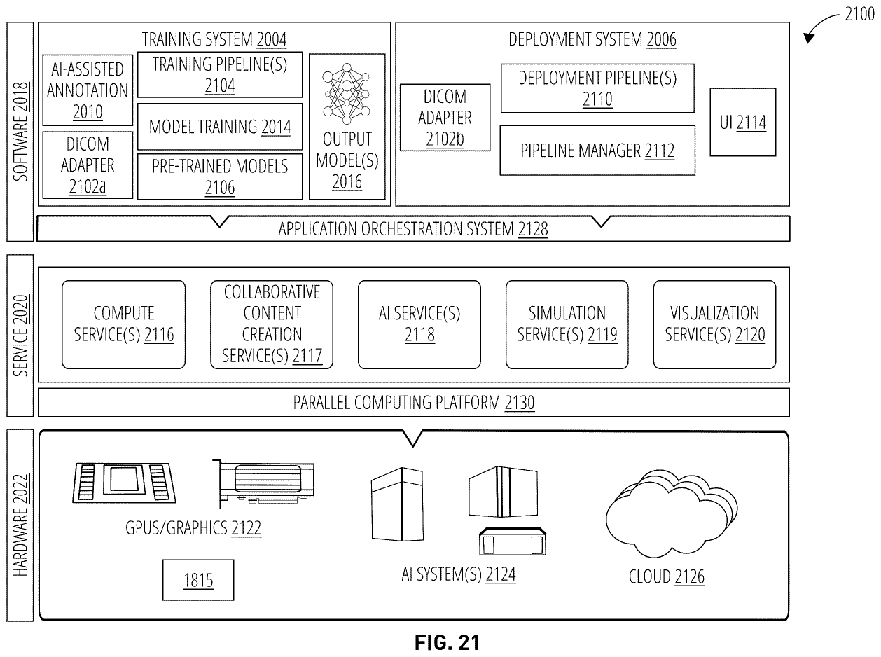

In at least one embodiment, a model registry 2024 may be backed by object storage that may support versioning and object metadata. In at least one embodiment, object storage may be accessible through, for example, a cloud storage (e.g., a cloud 2126 of FIG. 21) compatible application programming interface (API) from within a cloud platform. In at least one embodiment, machine learning models within model registry 2024 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline(s) 2104 (FIG. 21) may include a scenario where facility 2002 is training their own machine learning model or has an existing machine learning model that needs to be optimized or updated. In at least one embodiment, feedback data 2008 may be received from various channels, such as forums, web forms, or the like. In at least one embodiment, once feedback data 2008 is received, AI-assisted annotation 2010 may be used to aid in generating annotations corresponding to feedback data 2008 to be used as ground truth data for a machine learning model. In at least one embodiment, AI-assisted annotation 2010 may include one or more machine learning models (e.g., convolutional neural networks (CNNs)) that may be trained to generate annotations corresponding to certain types of feedback data 2008 (e.g., from certain devices) and/or certain types of anomalies in feedback data 2008. In at least one embodiment, AI-assisted annotations 2010 may then be used directly, or may be adjusted or fine-tuned using an annotation tool, to generate ground truth data. In at least one embodiment, in some examples, labeled data 2012 may be used as ground truth data for training a machine learning model. In at least one embodiment, AI-assisted annotations 2010, labeled data 2012, or a combination thereof may be used as ground truth data for training a machine learning model, e.g., via model training 2014 in FIG. 20 and/or FIG. 21. In at least one embodiment, a trained machine learning model may be referred to as an output model 2016, and may be used by deployment system 2006, as described herein.

In at least one embodiment, training pipeline(s) 2104 (FIG. 21) may include a scenario where facility 2002 needs a machine learning model for use in performing one or more processing tasks for one or more applications in deployment system 2006, but facility 2002 may not currently have such a machine learning model (or may not have a model that is optimized, efficient, or effective for such purposes). In at least one embodiment, an existing machine learning model may be selected from model registry 2024. In at least one embodiment, model registry 2024 may include machine learning models trained to perform a variety of different inference tasks on imaging data. In at least one embodiment, machine learning models in model registry 2024 may have been trained on imaging data from different facilities than facility 2002 (e.g., facilities that are remotely located). In at least one embodiment, machine learning models may have been trained on imaging data from one location, two locations, or any number of locations. In at least one embodiment, when being trained on imaging data, which may be a form of feedback data 2008, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 2024. In at least one embodiment, a machine learning model may then be retrained, or updated, at any number of other facilities, and a retrained or updated model may be made available in model registry 2024. In at least one embodiment, a machine learning model may then be selected from model registry 2024—and referred to as output model(s) 2016—and may be used in deployment system 2006 to perform one or more processing tasks for one or more applications of a deployment system.

In at least one embodiment, training pipeline(s) 2104 (FIG. 21) may be used in a scenario that includes facility 2002 requiring a machine learning model for use in performing one or more processing tasks for one or more applications in deployment system 2006, but facility 2002 may not currently have such a machine learning model (or may not have a model that is optimized, efficient, or effective for such purposes). In at least one embodiment, a machine learning model selected from model registry 2024 might not be fine-tuned or optimized for feedback data 2008 generated at facility 2002 because of differences in populations, genetic variations, robustness of training data used to train a machine learning model, diversity in anomalies of training data, and/or other issues with training data. In at least one embodiment, AI-assisted annotation 2010 may be used to aid in generating annotations corresponding to feedback data 2008 to be used as ground truth data for retraining or updating a machine learning model. In at least one embodiment, labeled data 2012 may be used as ground truth data for training a machine learning model. In at least one embodiment, retraining or updating a machine learning model may be referred to as model training 2014. In at least one embodiment, model training 2014 may include data—e.g., AI-assisted annotations 2010, labeled data 2012, or a combination thereof—that may be used as ground truth data for retraining or updating a machine learning model.

In at least one embodiment, deployment system 2006 may include software 2018, service 2020, hardware 2022, and/or other components, features, and functionality. In at least one embodiment, deployment system 2006 may include a software “stack,” such that software 2018 may be built on top of service 2020 and may use service 2020 to perform some or all processing tasks, and service 2020 and software 2018 may be built on top of hardware 2022 and use hardware 2022 to execute processing, storage, and/or other compute tasks of deployment system 2006.

In at least one embodiment, software 2018 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 2008 (or other data types, such as those described herein). In at least one embodiment, an advanced processing and inferencing pipeline may be defined based on selections of different containers that are desired or required for processing feedback data 2008, in addition to containers that receive and configure imaging data for use by each container and/or for use by facility 2002 after processing through a pipeline (e.g., to convert outputs back to a usable data type for storage and display at facility 2002). In at least one embodiment, a combination of containers within software 2018 (e.g., that make up a pipeline) may be referred to as a virtual instrument (as described in more detail herein), and a virtual instrument may leverage service 2020 and hardware 2022 to execute some or all processing tasks of applications instantiated in containers.

In at least one embodiment, data may undergo pre-processing as part of a data processing pipeline to prepare data for processing by one or more applications. In at least one embodiment, post-processing may be performed on an output of one or more inferencing tasks or other processing tasks of a pipeline to prepare output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 2016 of training system 2004.

In at least one embodiment, tasks of a data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 2024 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some services 2020 as a system (e.g., system 2100 of FIG. 21). In at least one embodiment, once validated by system 2100 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 2100 of FIG. 21). In at least one embodiment, completed and validated applications or containers may be stored in a container registry and associated machine learning models may be stored in model registry 2024. In at least one embodiment, a requesting entity that provides an inference or image processing request may browse a container registry and/or model registry 2024 for an application, container, dataset, machine learning model, etc., select a desired combination of elements for inclusion in a data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 2006 (e.g., a cloud) to perform processing of a data processing pipeline. In at least one embodiment, processing by deployment system 2006 may include referencing selected elements (e.g., applications, containers, models, etc.) from a container registry and/or model registry 2024. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, service 2020 may be leveraged. In at least one embodiment, service 2020 may include compute services, collaborative content creation services, simulation services, artificial intelligence (AI) services, visualization services, and/or other service types. In at least one embodiment, service 2020 may provide functionality that is common to one or more applications in software 2018, so functionality may be abstracted to a service that may be called upon or leveraged by applications. In at least one embodiment, functionality provided by service 2020 may run dynamically and more efficiently, while also scaling well by allowing applications to process data in parallel, e.g., using a parallel computing platform 2130 (FIG. 21). In at least one embodiment, rather than each application that shares the same functionality offered by a service 2020 being required to have a respective instance of service 2020, service 2020 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 2020 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 2018 implementing an advanced processing and inferencing pipeline may be streamlined because each application may call upon the same inference service to perform one or more inferencing tasks.

In at least one embodiment, hardware 2022 may include GPUs, CPUs, data processing units (DPUs), an AI/deep learning system (e.g., an AI supercomputer, such as NVIDIA's DGX™ supercomputer system), a cloud platform, or a combination thereof. In at least one embodiment, different types of hardware 2022 may be used to provide efficient, purpose-built support for software 2018 and service 2020 in deployment system 2006. In at least one embodiment, use of GPU processing may be implemented for processing locally (e.g., at facility 2002), within an AI/deep learning system, in a cloud system, and/or in other processing components of deployment system 2006 to improve efficiency, accuracy, and efficacy of game name recognition.

In at least one embodiment, software 2018 and/or service 2020 may be optimized for GPU processing with respect to deep learning, machine learning, and/or high-performance computing, simulation, and visual computing, as non-limiting examples. In at least one embodiment, at least some of the computing environment of deployment system 2006 and/or training system 2004 may be executed in a datacenter or one or more supercomputers or high performance computing systems, with GPU-optimized software (e.g., hardware and software combination of NVIDIA's DGX™ system). In at least one embodiment, hardware 2022 may include any number of GPUs that may be called upon to perform processing of data in parallel, as described herein. In at least one embodiment, a cloud platform may further include GPU processing for GPU-optimized execution of deep learning tasks, machine learning tasks, or other computing tasks. In at least one embodiment, a cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, a cloud platform may integrate an application container clustering system or orchestration system (e.g., KUBERNETES) on multiple GPUs to enable seamless scaling and load balancing.

FIG. 21 is a system diagram for an example system 2100 for generating and deploying a deployment pipeline, according to at least one embodiment. In at least one embodiment, system 2100 may be used to implement process 2000 of FIG. 20 and/or other processes including advanced processing and inferencing pipelines. In at least one embodiment, system 2100 may include training system 2004 and deployment system 2006. In at least one embodiment, training system 2004 and deployment system 2006 may be implemented using software 2018, services 2020, and/or hardware 2022, as described herein.

In at least one embodiment, system 2100 (e.g., training system 2004 and/or deployment system 2006) may be implemented in a cloud computing environment (e.g., using cloud 2126). In at least one embodiment, system 2100 may be implemented locally with respect to a facility, or as a combination of both cloud and local computing resources. In at least one embodiment, access to APIs in cloud 2126 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 2100, may be restricted to a set of public internet service providers (ISPs) that have been vetted or authorized for interaction.

In at least one embodiment, various components of system 2100 may communicate between and among one another using any of a variety of different network types, including but not limited to local area networks (LANs) and/or wide area networks (WANs) via wired and/or wireless communication protocols. In at least one embodiment, communication between facilities and components of system 2100 (e.g., for transmitting inference requests, for receiving results of inference requests, etc.) may be communicated over a data bus or data buses, wireless data protocols (e.g., Wi-Fi), wired data protocols (e.g., Ethernet), etc.

In at least one embodiment, training system 2004 may execute training pipelines 2104, similar to those described herein with respect to FIG. 20. In at least one embodiment, where one or more machine learning models are to be used in deployment pipeline(s) 2110 by deployment system 2006, training pipeline(s) 2104 may be used to train or retrain one or more (e.g., pre-trained) models, and/or implement one or more of pre-trained models 2106 (e.g., without a need for retraining or updating). In at least one embodiment, as a result of training pipeline(s) 2104, output model(s) 2016 may be generated. In at least one embodiment, training pipeline(s) 2104 may include any number of processing steps, AI-assisted annotation 2010, labeling or annotating of feedback data 2008 to generate labeled data 2012, model selection from a model registry, model training 2014, training, retraining, or updating models, and/or other processing steps. In at least one embodiment, DICOM adapter 2102a can be used to access DICOM data. In at least one embodiment, for different machine learning models used by deployment system 2006, different training pipeline(s) 2104 may be used. In at least one embodiment, training pipeline(s) 2104, similar to a first example described with respect to FIG. 20, may be used for a first machine learning model, training pipeline(s) 2104, similar to a second example described with respect to FIG. 20, may be used for a second machine learning model, and training pipeline(s) 2104, similar to a third example described with respect to FIG. 20, may be used for a third machine learning model. In at least one embodiment, any combination of tasks within training system 2004 may be used depending on what is required for each respective machine learning model. In at least one embodiment, one or more machine learning models may already be trained and ready for deployment so machine learning models may not undergo any processing by training system 2004 and may be implemented by deployment system 2006.

In at least one embodiment, output model(s) 2016 and/or pre-trained models 2106 may include any types of machine learning models depending on embodiment. In at least one embodiment, and without limitation, machine learning models used by system 2100 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipeline(s) 2104 may include AI-assisted annotation. In at least one embodiment, labeled data 2012 (e.g., traditional annotation) may be generated by any number of techniques. In at least one embodiment, labels or other annotations may be generated within a drawing program (e.g., an annotation program), a computer-aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 2008 (or other data type used by machine learning models), there may be corresponding ground truth data generated by training system 2004. In at least one embodiment, AI-assisted annotation may be performed as part of deployment pipeline(s) 2110; either in addition to, or in lieu of, AI-assisted annotation included in training pipeline(s) 2104. In at least one embodiment, system 2100 may include a multi-layer platform that may include a software layer (e.g., software 2018) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from external environment(s), e.g., facility 2002. In at least one embodiment, applications may then call or execute one or more services 2020 for performing compute, AI, or visualization tasks associated with respective applications, and software 2018 and/or services 2020 may leverage hardware 2022 to perform processing tasks in an effective and efficient manner.

In at least one embodiment, deployment system 2006 may execute deployment pipelines 2110. In at least one embodiment, deployment pipeline(s) 2110 may include any number of applications that may be sequentially, non-sequentially, or otherwise applied to feedback data (and/or other data types), including AI-assisted annotation, as described above. In at least one embodiment, as described herein, a deployment pipeline(s) 2110 for an individual device may be referred to as a virtual instrument for a device. In at least one embodiment, for a single device, there may be more than one deployment pipeline(s) 2110 depending on information desired from data generated by a device.

In at least one embodiment, applications available for deployment pipeline(s) 2110 may include any application that may be used for performing processing tasks on feedback data or other data from devices. In at least one embodiment, because various applications may share common image operations, in some embodiments, a data augmentation library (e.g., as one of services 2020) may be used to accelerate these operations. In at least one embodiment, to avoid bottlenecks of conventional processing approaches that rely on CPU processing, parallel computing platform 2130 may be used for GPU acceleration of these processing tasks.

In at least one embodiment, deployment system 2006 may include a user interface (UI) 2114 (e.g., a graphical user interface, a web interface, etc.) that may be used to select applications for inclusion in deployment pipeline(s) 2110, arrange applications, modify or change applications or parameters or constructs thereof, use and interact with deployment pipeline(s) 2110 during set-up and/or deployment, and/or to otherwise interact with deployment system 2006. In at least one embodiment, although not illustrated with respect to training system 2004, UI 2114 (or a different user interface) may be used for selecting models for use in deployment system 2006, for selecting models for training, or retraining, in training system 2004, and/or for otherwise interacting with training system 2004.

In at least one embodiment, pipeline manager 2112 may be used, in addition to an application orchestration system 2128, to manage interaction between applications or containers of deployment pipeline(s) 2110 and services 2020 and/or hardware 2022. In at least one embodiment, pipeline manager 2112 may be configured to facilitate interactions from application to application, from application to service 2020, and/or from application or service to hardware 2022. In at least one embodiment, although illustrated as included in software 2018, this is not intended to be limiting, and in some examples pipeline manager 2112 may be included in services 2020. In at least one embodiment, application orchestration system 2128 (e.g., Kubernetes, DOCKER, etc.) may include a container orchestration system that may group applications into containers as logical units for coordination, management, scaling, and deployment. In at least one embodiment, by associating applications from deployment pipeline(s) 2110 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 2112 and application orchestration system 2128. In at least one embodiment, so long as an expected input and/or output of each container or application is known by a system (e.g., based on constructs of applications or containers), application orchestration system 2128 and/or pipeline manager 2112 may facilitate communication among and between, and sharing of resources among and between, each of the applications or containers. In at least one embodiment, because one or more applications or containers in deployment pipeline(s) 2110 may share the same services and resources, application orchestration system 2128 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 2128) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 2020 leveraged and shared by applications or containers in deployment system 2006 may include compute service(s) 2116, collaborative content creation service(s) 2117, AI service(s) 2118, simulation service(s) 2119, visualization service(s) 2120, and/or other service types. In at least one embodiment, applications may call (e.g., execute) one or more services 2020 to perform processing operations for an application. In at least one embodiment, compute service(s) 2116 may be leveraged by applications to perform super-computing or other high-performance computing (HPC) tasks. In at least one embodiment, compute service(s) 2116 may be leveraged to perform parallel processing (e.g., using a parallel computing platform 2130) for processing data through one or more of applications and/or one or more tasks of a single application, substantially simultaneously. In at least one embodiment, parallel computing platform 2130 (e.g., NVIDIA's CUDA®) may enable general purpose computing on GPUs (GPGPU) (e.g., GPUs/graphics 2122). In at least one embodiment, a software layer of parallel computing platform 2130 may provide access to virtual instruction sets and parallel computational elements of GPUs, for execution of compute kernels. In at least one embodiment, parallel computing platform 2130 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 2130 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 2118 may be leveraged to perform inferencing services for executing machine learning model(s) associated with applications (e.g., tasked with performing one or more processing tasks of an application). In at least one embodiment, AI service(s) 2118 may leverage AI system(s) 2124 to execute machine learning model(s) (e.g., neural networks, such as CNNs) for segmentation, reconstruction, object detection, feature detection, classification, and/or other inferencing tasks. In at least one embodiment, applications of deployment pipeline(s) 2110 may use one or more of output model(s) 2016 from training system 2004 and/or other models of applications to perform inference on imaging data (e.g., DICOM data, RIS data, CIS data, REST compliant data, RPC data, raw data, etc.). For example, DICOM adapter 2102b may be used to access DICOM data. In at least one embodiment, two or more examples of inferencing using application orchestration system 2128 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 2128 may distribute resources (e.g., services 2020 and/or hardware 2022) based on priority paths for different inferencing tasks of AI service(s) 2118.

In at least one embodiment, shared storage may be mounted to AI service(s) 2118 within system 2100. In at least one embodiment, shared storage may operate as a cache (or other storage device type) and may be used to process inference requests from applications. In at least one embodiment, when an inference request is submitted, a request may be received by a set of API instances of deployment system 2006, and one or more instances may be selected (e.g., for best fit, for load balancing, etc.) to process a request. In at least one embodiment, to process a request, a request may be entered into a database, a machine learning model may be located from model registry 2024 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 2112) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that the same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from the requesting institution or entity and may include partner network traversal time, as well as execution on an inference service.

In at least one embodiment, transfer of requests between services 2020 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with the most instances of an application connected to it, while lowest priority work may go to a queue with a single instance connected to it that processes tasks in the order received. In at least one embodiment, an application may run on a GPU-accelerated instance generated in cloud 2126, and an inference service may perform inferencing on a GPU.

In at least one embodiment, visualization service(s) 2120 may be leveraged to generate visualizations for viewing outputs of applications and/or deployment pipeline(s) 2110. In at least one embodiment, GPUs/graphics 2122 may be leveraged by visualization service(s) 2120 to generate visualizations. In at least one embodiment, rendering effects, such as ray-tracing or other light transport simulation techniques, may be implemented by visualization service(s) 2120 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 2120 may include an internal visualizer, cinematics, and/or other rendering or image processing capabilities or functionality (e.g., ray tracing, rasterization, internal optics, etc.).

In at least one embodiment, hardware 2022 may include GPUs/graphics 2122, AI system(s) 2124, cloud 2126, and/or any other hardware used for executing training system 2004 and/or deployment system 2006. In at least one embodiment, GPUs/graphics 2122 (e.g., NVIDIA's TESLA® and/or QUADRO® GPUs) may include any number of GPUs that may be used for executing processing tasks of compute service(s) 2116, collaborative content creation service(s) 2117, AI service(s) 2118, simulation service(s) 2119, visualization service(s) 2120, other services, and/or any features or functionality of software 2018. For example, with respect to AI service(s) 2118, GPUs/graphics 2122 may be used to perform pre-processing on imaging data (or other data types used by machine learning models), post-processing on outputs of machine learning models, and/or to perform inferencing (e.g., to execute machine learning models). In at least one embodiment, cloud 2126, AI system(s) 2124, and/or other components of system 2100 may use GPUs/graphics 2122. In at least one embodiment, cloud 2126 may include a GPU-optimized platform for deep learning tasks. In at least one embodiment, AI system(s) 2124 may use GPUs, and cloud 2126—or at least a portion tasked with deep learning or inferencing—may be executed using one or more AI system(s) 2124. As such, although hardware 2022 is illustrated as discrete components, this is not intended to be limiting, and any components of hardware 2022 may be combined with, or leveraged by, any other components of hardware 2022.

In at least one embodiment, AI system(s) 2124 may include a purpose-built computing system (e.g., a super-computer or an HPC) configured for inferencing, deep learning, machine learning, and/or other artificial intelligence tasks. In at least one embodiment, AI system(s) 2124 (e.g., NVIDIA's DGX™) may include GPU-optimized software (e.g., a software stack) that may be executed using a plurality of GPUs/graphics 2122, in addition to CPUs, RAM, storage, and/or other components, features, or functionality. In at least one embodiment, one or more AI system(s) 2124 may be implemented in cloud 2126 (e.g., in a data center) for performing some or all AI-based processing tasks of system 2100.

In at least one embodiment, cloud 2126 may include a GPU-accelerated infrastructure (e.g., NVIDIA's NGC™) that may provide a GPU-optimized platform for executing processing tasks of system 2100. In at least one embodiment, cloud 2126 may include an AI system(s) 2124 for performing one or more AI-based tasks of system 2100 (e.g., as a hardware abstraction and scaling platform). In at least one embodiment, cloud 2126 may integrate with application orchestration system 2128 leveraging multiple GPUs to enable seamless scaling and load balancing between and among applications and services 2020. In at least one embodiment, cloud 2126 may be tasked with executing at least some services 2020 of system 2100, including compute service(s) 2116, AI service(s) 2118, and/or visualization service(s) 2120, as described herein. In at least one embodiment, cloud 2126 may perform small and large batch inference (e.g., executing NVIDIA's TensorRT™), provide an accelerated parallel computing platform 2130 (e.g., NVIDIA's CUDA®), execute application orchestration system 2128 (e.g., KUBERNETES), provide a graphics rendering API and platform (e.g., for ray-tracing, 2D graphics, 3D graphics, and/or other rendering techniques to produce higher quality cinematics), and/or may provide other functionality for system 2100. In at least one embodiment, parallel computing platform 2130 may include an API.

In at least one embodiment, in an effort to preserve patient confidentiality (e.g., where patient data or records are to be used off-premises), cloud 2126 may include a registry, such as a deep learning container registry. In at least one embodiment, a registry may store containers for instantiations of applications that may perform pre-processing, post-processing, or other processing tasks on patient data. In at least one embodiment, cloud 2126 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Neural Network Training and Deployment

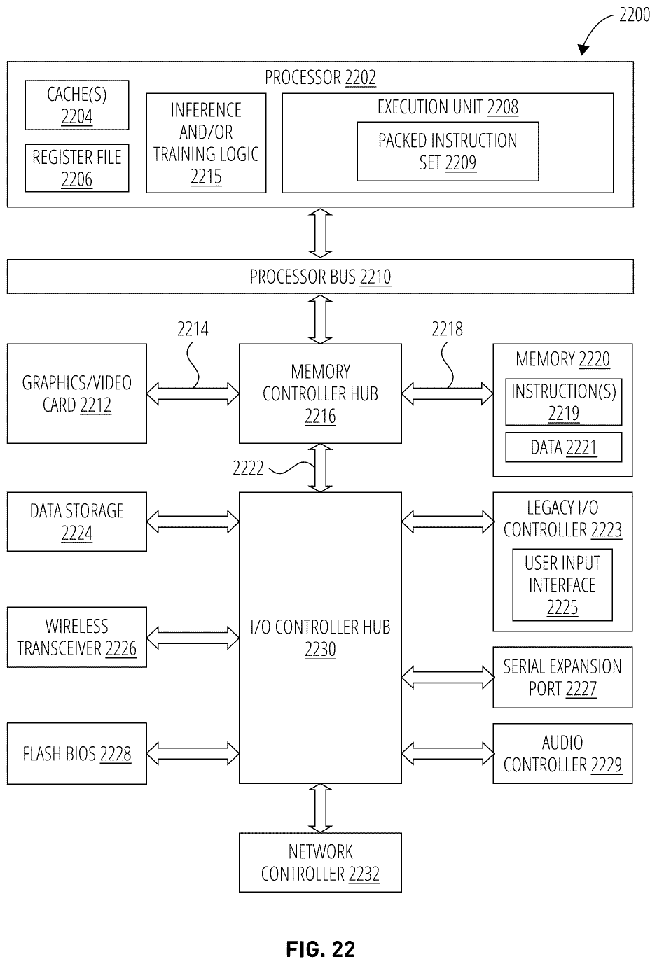

FIG. 22 is a block diagram illustrating an exemplary computer system 2200, which may be a system with interconnected devices and components, a system-on-a-chip (SOC) or some combination thereof formed with a processor that may include execution units to execute an instruction, according to at least one embodiment. In at least one embodiment, computer system 2200 may include, without limitation, a component, such as a processor 2202 to employ execution units including logic to perform algorithms for process data, in accordance with present disclosure, such as in embodiment described herein. In at least one embodiment, computer system 2200 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 2200 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 2200 may include, without limitation, processor 2202 that may include, without limitation, one or more execution units 2208 to perform machine learning model training and/or inferencing according to techniques described herein. In at least one embodiment, computer system 2200 is a single processor desktop or server system, but in another embodiment, computer system 2200 may be a multiprocessor system. In at least one embodiment, processor 2202 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 2202 may be coupled to a processor bus 2210 that may transmit data signals between processor 2202 and other components in computer system 2200.

In at least one embodiment, processor 2202 may include, without limitation, a Level 1 (“L1”) internal cache memory (“cache”) 2204. In at least one embodiment, processor 2202 may have a single internal cache or multiple levels of internal cache. In at least one embodiment, cache memory may reside externally to processor 2202. Other embodiments may also include a combination of both internal and external caches depending on particular implementation and needs.

In at least one embodiment, processor 2202 may include, without limitation, a Level 2 (“L2”) internal cache memory (“cache”) 2204. The L2 cache can serve as a secondary, larger, and somewhat slower cache compared to the L1 cache that is still faster than accessing the main memory (e.g., via the memory controller hub 2216). Thus, the L2 cache can enhance performance by reducing the time the processor spends accessing the main memory. In at least one embodiment, processor 2202 may have a single internal L2 cache or multiple levels of internal cache. In embodiments where the processor 2202 is a multi-core processor, the L2 cache can be shared among multiple cores of processor 2202, providing a larger, intermediate level of cache memory for more than one processing core. In at least one embodiment, L2 cache memory may reside externally to processor 2202.

In at least one embodiment, processor 2202 may include, without limitation, a Level 3 (“L3”) internal cache memory (“cache”) 2204. The L3 cache can serve as a tertiary, larger, and slower cache compared to both the L1 and L2 caches. The L3 cache can enhance performance by reducing the time the processor spends accessing the main memory. The L3 cache can be shared among multiple cores of processor 2202, providing a larger pool of fast-access memory for data for the processor cores. In at least one embodiment, processor 2202 may have a single internal L3 cache or multiple levels of internal cache. In at least one embodiment, L3 cache memory may reside externally to processor 2202. Other embodiments may also include any combination of internal or external L1, L2, and/or L3 caches depending on particular implementation and needs. In at least one embodiment, register file 2206 may store different types of data in various registers including, without limitation, integer registers, floating point registers, status registers, and instruction pointer register.

In at least one embodiment, execution unit 2208, including, without limitation, logic to perform integer and floating point operations, also resides in processor 2202. In at least one embodiment, processor 2202 may also include a microcode (“ucode”) read only memory (“ROM”) that stores microcode for certain macro instructions. In at least one embodiment, execution unit 2208 may include logic to handle a packed instruction set 2209. In at least one embodiment, by including packed instruction set 2209 in an instruction set of a general-purpose processor 2202, along with associated circuitry to execute instructions, operations used by many multimedia applications may be performed using packed data in a general-purpose processor 2202. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 2208 may also be used in microcontrollers, embedded processors, graphics devices, DSPs, and other types of logic circuits. In at least one embodiment, computer system 2200 may include, without limitation, a memory 2220. In at least one embodiment, memory 2220 may be implemented as a Dynamic Random Access Memory (“DRAM”) device, a Static Random Access Memory (“SRAM”) device, flash memory device, or other memory device. In at least one embodiment, memory 2220 may store instruction(s) 2219 and/or data 2221 represented by data signals that may be executed by processor 2202.

In at least one embodiment, system logic chip may be coupled to processor bus 2210 and memory 2220. In at least one embodiment, system logic chip may include, without limitation, a memory controller hub (“MCH”) 2216, and processor 2202 may communicate with MCH 2216 via processor bus 2210. In at least one embodiment, MCH 2216 may provide a high bandwidth memory path 2218 to memory 2220 for instruction and data storage and for storage of graphics commands, data, and textures. In at least one embodiment, MCH 2216 may direct data signals between processor 2202, memory 2220, and other components in computer system 2200 and to bridge data signals between processor bus 2210, memory 2220, and a system I/O 2222. In at least one embodiment, system logic chip may provide a graphics port for coupling to a graphics controller. In at least one embodiment, MCH 2216 may be coupled to memory 2220 through a high bandwidth memory path 2218 and graphics/video card 2212 may be coupled to MCH 2216 through an Accelerated Graphics Port (“AGP”) interconnect 2214.

In at least one embodiment, computer system 2200 may use system I/O 2222 that is a proprietary hub interface bus to couple MCH 2216 to I/O controller hub (“ICH”) 2230. In at least one embodiment, ICH 2230 may provide direct connections to some I/O devices via a local I/O bus. In at least one embodiment, local I/O bus may include, without limitation, a high-speed I/O bus for connecting peripherals to memory 2220, chipset, and processor 2202. Examples may include, without limitation, an audio controller 2229, a firmware hub (“flash BIOS”) 2228, a wireless transceiver 2226, a data storage 2224, a legacy I/O controller 2223 containing user input and keyboard interfaces 2225, a serial expansion port 2227, such as Universal Serial Bus (“USB”), and a network controller 2232, which may include in some embodiments, a data processing unit. Data storage 2224 may comprise a hard disk drive, a floppy disk drive, a CD-ROM device, a flash memory device, or other mass storage device.

In at least one embodiment, FIG. 22 illustrates a system, which includes interconnected hardware devices or “chips”, whereas in other embodiments, FIG. 22 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 2200 are interconnected using compute express link (CXL) interconnects.

Inference and/or training logic 2215 are used to perform inferencing and/or training operations associated with one or more embodiments. The inference and/or training logic 2215 may include same or similar features of training logic/hardware structure(s) 1815. Details training logic/hardware structure(s) 1815 are provided in conjunction with FIG. 18A and/or FIG. 18B. In at least one embodiment, inference and/or training logic 2215 may be used in system FIG. 22 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

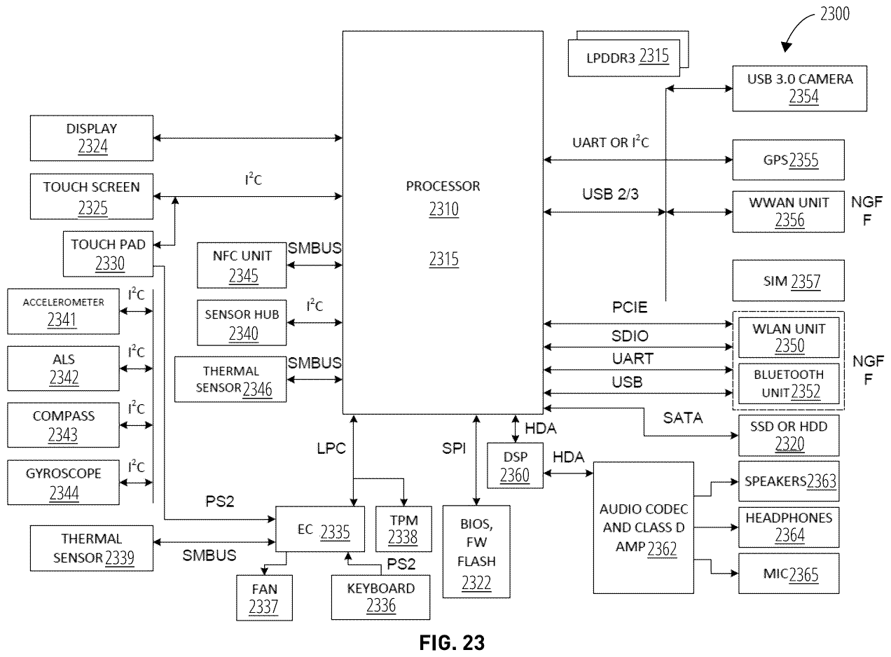

FIG. 23 is a block diagram illustrating an electronic device 2300 for utilizing a processor 2310, according to at least one embodiment. In at least one embodiment, electronic device 2300 may be, for example and without limitation, a notebook, a tower server, a rack server, a blade server, a laptop, a desktop, a tablet, a mobile device, a phone, an embedded computer, an edge device, an IoT device, or any other suitable electronic device.

In at least one embodiment, electronic device 2300 may include, without limitation, processor 2310 communicatively coupled to any suitable number or kind of components, peripherals, modules, or devices. In at least one embodiment, processor 2310 coupled using a bus or interface, such as a I2C bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 23 illustrates a system, which includes interconnected hardware devices or “chips”, whereas in other embodiments, FIG. 23 may illustrate an exemplary System on a Chip (“SoC”). In at least one embodiment, devices illustrated in FIG. 23 may be interconnected with proprietary interconnects, standardized interconnects (e.g., PCIe) or some combination thereof. In at least one embodiment, one or more components of FIG. 23 are interconnected using compute express link (CXL) interconnects.

In at least one embodiment, FIG. 23 may include a display 2324, a touch screen 2325, a touch pad 2330, a Near Field Communications unit (“NFC”) 2345, a sensor hub 2340, a thermal sensor 2346, an Express Chipset (“EC”) 2335, a Trusted Platform Module (“TPM”) 2338, BIOS/firmware/flash memory (“BIOS, FW Flash”) 2322, a DSP 2360, a drive 2320 such as a Solid State Disk (“SSD”) or a Hard Disk Drive (“HDD”), a wireless local area network unit (“WLAN”) 2350, a Bluetooth unit 2352, a Wireless Wide Area Network unit (“WWAN”) 2356, a Global Positioning System (GPS) 2355, a camera (“USB 3.0 camera”) 2354 such as a USB 3.0 camera, and/or a Low Power Double Data Rate (“LPDDR”) memory unit (“LPDDR3”) 2315 implemented in, for example, LPDDR3 standard. These components may each be implemented in any suitable manner.

In at least one embodiment, other components may be communicatively coupled to processor 2310 through components discussed above. In at least one embodiment, an accelerometer 2341, Ambient Light Sensor (“ALS”) 2342, compass 2343, and a gyroscope 2344 may be communicatively coupled to sensor hub 2340. In at least one embodiment, thermal sensor 2339, a fan 2337, a keyboard 2336, and a touch pad 2330 may be communicatively coupled to EC 2335. In at least one embodiment, speaker 2363, headphones 2364, and microphone (“mic”) 2365 may be communicatively coupled to an audio unit (“audio codec and class d amp”) 2362, which may in turn be communicatively coupled to DSP 2360. In at least one embodiment, audio unit 2362 may include, for example and without limitation, an audio coder/decoder (“codec”) and a class D amplifier. In at least one embodiment, SIM card (“SIM”) 2357 may be communicatively coupled to WWAN unit 2356. In at least one embodiment, components such as WLAN unit 2350 and Bluetooth unit 2352, as well as WWAN unit 2356 may be implemented in a Next Generation Form Factor (“NGFF”).

Inference and/or training logic/hardware structures 1815 are used to perform inferencing and/or training operations associated with one or more embodiments. Details regarding training logic/hardware structure(s) 1815 are provided in conjunction with FIG. 18A and/or FIG. 18B. In at least one embodiment, inference and/or training logic structures 1815 may be used in system FIG. 23 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of the following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure, and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In the description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout the specification, terms such as “processing,” “computing,” “calculating,” “determining,” or the like, refer to action and/or processes of a computer or computing system, or similar electronic computing device, that manipulate and/or transform data represented as physical, such as electronic, quantities within a computing system's registers and/or memories into other data similarly represented as physical quantities within a computing system's memories, registers, or other such information storage, transmission, or display devices.

In a similar manner, the term “processor” may refer to any device or portion of a device that processes electronic data from registers and/or memory and transforms that electronic data into other electronic data that may be stored in registers and/or memory. As a non-limiting example, a “processor” may be a network device. A “computing platform” may comprise one or more processors. As used herein, “software” processes may include, for example, software and/or hardware entities that perform work over time, such as tasks, threads, and intelligent agents. Also, each process may refer to multiple processes for continuously or intermittently carrying out instructions in sequence or in parallel. In at least one embodiment, the terms “system” and “method” are used herein interchangeably as far as the system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or an inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in the appended claims is not necessarily limited to specific features or acts described. Rather, specific features and acts are disclosed as exemplary forms of implementing the claims.

1. A communication system comprising:
a receiver circuit;
a Forward Error Correction (FEC) circuit operatively coupled to the receiver circuit; and
a processing device operatively coupled to the receiver circuit and the FEC circuit, wherein the processing device is to:
receive measurement data comprising at least one of transmitter settings and impairment properties associated with a transmitter circuit, channel properties and impairment properties associated with a channel between the transmitter circuit and the receiver circuit, link properties and impairment properties associated with a link between the transmitter circuit and the receiver circuit, or receiver settings and impairment properties associated with the receiver circuit;
determine, using the measurement data and a deep neural network (DNN), a post-FEC BER estimation of the FEC circuit; and
adjust, based on the post-FEC BER estimation, at least one of a FEC parameter of the FEC circuit or a link parameter of the transmitter or receiver circuit.

2. The communication system of claim 1, wherein the DNN is trained based on training data and at least one of a codeword histogram, a burst histogram, or a signal-to-noise ratio (SNR) histogram, wherein the training data comprises at least one of additional transmitter settings and impairment properties associated with the transmitter circuit, additional channel properties and impairment properties associated with the channel between the transmitter circuit and the receiver circuit, additional link properties and impairment properties associated with the link between the transmitter circuit and the receiver circuit, additional receiver settings and impairment properties associated with the receiver circuit, or environmental properties.

3. The communication system of claim 2, wherein the training data comprises pre-FEC performance training data.

4. The communication system of claim 2, wherein, to train the DNN, the processing device is to:
determine, using the DNN with current model parameters, a first training post-FEC BER estimation;
determine, using a semi-analytic model and the at least one of the codeword histogram, the burst histogram, or the SNR histogram, a second training post-FEC BER estimation;
determine an error signal between the first training post-FEC BER estimation and the second training post-FEC BER estimation;
update, using the error signal, the current model parameters to obtain trained model parameters for the DNN; and
output trained model parameters of the DNN.

5. The communication system of claim 2, wherein the training data comprises pre-FEC performance training data, wherein, to train the DNN, the processing device is to:
determine, using the DNN with current model parameters, a first training post-FEC BER estimation;
determine, using a semi-analytic model and the at least one of the codeword histogram, the burst histogram, or the SNR histogram, a second training post-FEC BER estimation;
determine, using a random error model and the pre-FEC performance training data, a third training post-FEC BER estimation;
determine a difference estimation between the second training post-FEC BER estimation and the third training post-FEC BER estimation;
determine an error signal between the first training post-FEC BER estimation and the third training post-FEC BER estimation;
update, using the error signal, the current model parameters to obtain trained model parameters for the DNN;
output trained model parameters of the DNN;
determine, using the DNN with the trained model parameters, second difference estimation;
determine, using pre-FEC performance data and the random error model, a second post-FEC BER estimation; and
determine, using the second difference estimation and the second post-FEC BER estimation, the post-FEC BER estimation.

6. The communication system of claim 1, wherein:
the FEC circuit comprises:
an interleaver; and
a decoder;
the FEC parameter is an interleave factor of the interleaver; and
the processing device, to adjust at least one of the FEC parameter or the link parameter, is to change the interleave factor from a first value to a second value.

7. The communication system of claim 1, wherein the receiver circuit comprises a serializer/deserializer (SerDes) circuit, wherein:
the link parameter is a SerDes parameter of the SerDes circuit; and
the processing device, to adjust at least one of the FEC parameter or the link parameter, is to change the SerDes parameter from a first value to a second value.

8. The communication system of claim 1, wherein the receiver circuit comprises a serializer/deserializer (SerDes) circuit, wherein:
the FEC circuit comprises an interleaver;
the FEC parameter is an interleave factor of the interleaver;
the link parameter is a SerDes parameter of the SerDes circuit; and
the processing device, to adjust at least one of the FEC parameter or the link parameter, is to:
change the interleave factor from a first value to a second value; and
change the SerDes parameter from a third value to a fourth value.

9. The communication system of claim 1, further comprising:
a receiver comprising the receiver circuit, the FEC circuit, and the processing device; and
a transmitter comprising a second FEC circuit, wherein the processing device is further to send an indication to the second FEC circuit, the indication to adjust an FEC parameter of the second FEC circuit.

10. The communication system of claim 1, wherein:
the FEC circuit comprises:
a first interleaver;
a first decoder;
a second interleaver;
a second decoder;
the FEC parameter includes a first interleave factor of the first interleaver and a second interleave factor of the second interleaver; and
the processing device, to adjust at least one of the FEC parameter or the link parameter, is to:
change the first interleave factor from a first value to a second value; and
change the second interleave factor from a third value to a fourth value.

11. A method comprising:
receiving measurement data comprising at least one of transmitter settings and impairment properties associated with a transmitter circuit, channel properties and impairment properties associated with a channel between the transmitter circuit and a receiver circuit, link properties and impairment properties associated with a link between the transmitter circuit and the receiver circuit, or receiver settings and impairment properties associated with the receiver circuit;
determining, using the measurement data and a deep neural network (DNN), a post-FEC BER estimation of a Forward Error Correction (FEC) system; and
adjusting, based on the post-FEC BER estimation, at least one of a FEC parameter of the FEC system or a link parameter of the transmitter or receiver circuit.

12. The method of claim 11, wherein the DNN is trained based on training data and at least one of a codeword histogram, a burst histogram, or a signal-to-noise ratio (SNR) histogram, wherein the training data comprises at least one of additional transmitter settings and impairment properties associated with the transmitter circuit, additional channel properties and impairment properties associated with the channel between the transmitter circuit and the receiver circuit, additional link properties and impairment properties associated with the link between the transmitter circuit and the receiver circuit, additional receiver settings and impairment properties associated with the receiver circuit, or environmental properties.

13. The method of claim 11, further comprising training the DNN by:
determining, using the DNN with current model parameters, a first training post-FEC BER estimation;
determining, using a semi-analytic model and at least one of a codeword histogram, a burst histogram, or a signal-to-noise ratio (SNR) histogram, a second training post-FEC BER estimation;
determining an error signal between the first training post-FEC BER estimation and the second training post-FEC BER estimation;
updating, using the error signal, the current model parameters to obtain trained model parameters for the DNN; and
outputting trained model parameters of the DNN.

14. The method of claim 11, further comprising training the DNN by:
determining, using the DNN with current model parameters, a first training post-FEC BER estimation;
determining, using a semi-analytic model and at least one of a codeword histogram, a burst histogram, or a signal-to-noise ratio (SNR) histogram, a second training post-FEC BER estimation;
determining, using a random error model and pre-FEC performance training data, a third training post-FEC BER estimation;
determining a difference estimation between the second training post-FEC BER estimation and the third training post-FEC BER estimation;
determining an error signal between the first training post-FEC BER estimation and the third training post-FEC BER estimation;
updating, using the error signal, the current model parameters to obtain trained model parameters for the DNN;
outputting trained model parameters of the DNN;
determining, using the DNN with the trained model parameters, second difference estimation;
determining, using pre-FEC performance data and the random error model, a second post-FEC BER estimation; and
determining, using the second difference estimation and the second post-FEC BER estimation, the post-FEC BER estimation.

15. The method of claim 11, wherein adjusting at least one of the FEC parameter or the link parameter comprises changing an interleave factor of an interleaver of the FEC system from a first value to a second value.

16. The method of claim 11, wherein the receiver circuit is a Serializer/Deserializer (SerDes) circuit, wherein adjusting at least one of the FEC parameter or the link parameter comprises changing a SerDes parameter of the SerDes circuit from a first value to a second value.

17. The method of claim 11, wherein the receiver circuit is a Serializer/Deserializer (SerDes) circuit, wherein adjusting at least one of the FEC parameter or the link parameter comprises:
changing an interleave factor of an interleaver of the FEC system from a first value to a second value; and
changing a SerDes parameter of the SerDes circuit from a third value to a fourth value.

18. A communication system comprising:
a Serializer/Deserializer (SerDes) circuit coupled to a communication channel;
a Forward Error Correction (FEC) system operatively coupled to the SerDes circuit; and
a processing device operatively coupled to the SerDes circuit and the FEC system, wherein the processing device is to:
receive measurement data comprising at least one of transmitter settings and impairment properties associated with a transmitter circuit, channel properties and impairment properties associated with a channel between the transmitter circuit and the SerDes circuit, link properties and impairment properties associated with a link between the transmitter circuit and the SerDes circuit, or SerDes settings and impairment properties associated with the SerDes circuit;
determine, using the measurement data and a deep neural network (DNN), a post-FEC BER estimation of the FEC system; and
change, based on the post-FEC BER estimation, one or more parameters of the FEC system or the transmitter circuit or SerDes circuit.

19. The communication system of claim 18, wherein the DNN is trained based on training data and at least one of a codeword histogram, a burst histogram, or a signal-to-noise ratio (SNR) histogram, wherein the training data comprises at least one of additional transmitter settings and impairment properties associated with the transmitter circuit, additional channel properties and impairment properties associated with the channel between the transmitter circuit and the SerDes circuit, additional link properties and impairment properties associated with the link between the transmitter circuit and the SerDes circuit, or additional SerDes settings and impairment properties associated with the SerDes circuit.

20. The communication system of claim 19, wherein the training data comprises pre-FEC performance training data.

21. The communication system of claim 19, wherein, to train the DNN, the processing device is to:
determine, using the DNN with current model parameters, a first training post-FEC BER estimation;
determine, using a semi-analytic model and the at least one of the codeword histogram, the burst histogram, or the SNR histogram, a second training post-FEC BER estimation;
determine an error signal between the first training post-FEC BER estimation and the second training post-FEC BER estimation;
update, using the error signal, the current model parameters to obtain trained model parameters for the DNN; and
output trained model parameters of the DNN.

22. The communication system of claim 19, wherein the training data comprises pre-FEC performance training data, wherein, to train the DNN, the processing device is to:
determine, using the DNN with current model parameters, a first training post-FEC BER estimation;
determine, using a semi-analytic model and the at least one of the codeword histogram, the burst histogram, or the SNR histogram, a second training post-FEC BER estimation;
determine, using a random error model and the pre-FEC performance training data, a third training post-FEC BER estimation;
determine a difference estimation between the second training post-FEC BER estimation and the third training post-FEC BER estimation;
determine an error signal between the first training post-FEC BER estimation and the third training post-FEC BER estimation;
update, using the error signal, the current model parameters to obtain trained model parameters for the DNN;
output trained model parameters of the DNN;
determine, using the DNN with the trained model parameters, second difference estimation;
determine, using pre-FEC performance data and the random error model, a second post-FEC BER estimation; and
determine, using the second difference estimation and the second post-FEC BER estimation, the post-FEC BER estimation.

23. The communication system of claim 18, wherein:
the FEC system comprises:
an interleaver; and
a decoder;
the one or more parameters comprise an interleave factor of the interleaver; and
the processing device, to change the one or more parameters of the FEC system or the SerDes circuit, is to change the interleave factor from a first value to a second value.

24. The communication system of claim 18, wherein the FEC system comprises:
a first interleaver;
a first decoder;
a second interleaver;
a second decoder;
the one or more parameters comprise a first interleave factor of the first interleaver and a second interleave factor of the second interleaver and
the processing device, to change the one or more parameters of the FEC system or the SerDes circuit, is to:
change the first interleave factor from a first value to a second value; and
change the second interleave factor from a third value to a fourth value.

25. A system for high-speed network communication, the system comprising:
a processing unit; and
a network interface coupled to the processing unit, wherein the network interface comprises a transceiver comprising:
a receiver circuit;
a Forward Error Correction (FEC) circuit operatively coupled to the receiver circuit, wherein the processing unit is to:
receive measurement data comprising at least one of transmitter settings and impairment properties associated with a transmitter circuit, channel properties and impairment properties associated with a channel between the transmitter circuit and the receiver circuit, link properties and impairment properties associated with a link between the transmitter circuit and the receiver circuit, or receiver settings and impairment properties associated with the receiver circuit;
determine, using the measurement data and a deep neural network (DNN), a post-FEC BER estimation of the FEC circuit; and
adjust, based on the post-FEC BER estimation, at least one of a FEC parameter of the FEC circuit or a link parameter of the transmitter or receiver circuit.

26. The system of claim 25, wherein the processing unit comprises at least one of a central processing unit (CPU), a graphics processing unit (GPU), a data processing unit (DPU), a network adapter, a network switch, or an NVLink switch.
